(19) United States
(12) Patent Application Publication
(10) Pub. No.: US 2004/0205737 A1
(43) Pub. Date: Oct. 14, 2004

(54) Fast linguistic parsing system

(76) Inventors: Sasson Margaliot, Jerusalem (IL); Benjamin Wilshinsky Murray, Jerusalem (IL); Bruce Krulwich, Beit Shemesh (IL); Alexander Demidov, Yizhar Samaria (IL); Eyal Sagi, Herzelia (IL)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 10/473,892

(22) PCT Filed: Apr. 1, 2002
(86) PCT No.: PCT/IL02/00271

(30) Foreign Application Priority Data
Apr. 3, 2001 (IL) 142421

(51) Int. Cl. G06F 9/45

(52) U.S. Cl. 717/143

(57) ABSTRACT

A speedy and resource efficient parsing engine and parsing method for natural language parsing including a sentence receiver and a parser which employs a pre-compiled grammar to parse sentences.

### FIELD OF THE INVENTION

The present invention relates to parsing engines and parsing methodologies generally and more particularly to natural language parsing.

### REFERENCE TO CO-PENDING APPLICATION

Applicants hereby claim priority of Israel Patent Application No. 142,421 filed Apr. 3, 2001, entitled “Linguistic Agent System”.

### BACKGROUND OF THE INVENTION

The following patents are believed to represent the current state of the art:

U.S. Pat. Nos. 6,332,118; 6,330,530; 6,278,996; 6,223,150 and 6,081,774.

Reference is also made herein to the following prior art references:

Martha McGinnis, 2001, “Object asymmetries in a phase theory of syntax”, to appear in the Proceedings of the 2001 CLA Annual Conference, Department of Linguistics, University of Ottawa.

Peter Svenonius, 2001, “On object shift, scrambling, and the PIC”, to appear in Peter Svenonius (ed.), Subjects, Expletives, and the Extended Projection Principle, Oxford University Press.

### SUMMARY OF THE INVENTION

The present invention seeks to provide a parsing engine and parsing functionality which is speedy and resource efficient.

There is thus provided in accordance with a preferred embodiment of the present invention a parsing engine including a sentence receiver and a parser which employs a pre-compiled grammar to parse sentences received by the sentence receiver.

There is also provided in accordance with another preferred embodiment of tile present invention a parsing engine including a sentence receiver and a parser which employs a grammar, which has been pre-compiled, not in real time, to a set of sequences of types of words which can be directly matched to at least part of a sentence received by the sentence receiver.

These is further provided in accordance with yet another preferred embodiment of the present invention a parsing engine including a sentence receiver and a parser which employs syntactic templates and associated partial parse trees, where at least some of the syntactic templates can be matched to sequences of types of words of complete sentences.

There is also provided in accordance with still another preferred embodiment of the present invention a parsing engine including a sentence receiver and a parses which can parse most complete sentences up to a predetermined size at a speed substantially faster than sentences exceeding the predetermined size.

There is further provided in accordance with another preferred embodiment of the present invention a parsing engine including a sentence receiver and a parser which employs syntactic templates and associated partial parse trees, where at least some of the syntactic templates can be matched to sequences of types of words of at least parts of sentences.

There is also provided in accordance with yet another preferred embodiment of the present invention a parsing engine including a sentence receiver and an at least partial parser which employs templates with associated partial parse trees which can be matched to sequences of types of words of at least parts of sentences, thereby enabling parsing of parts of sentences at partial sentence parsing speeds greatly in excess of full sentence parsing speeds attainable when parsing full sentences.

There is further provided in accordance with still another preferred embodiment of the present invention a parsing engine including a sentence receiver and a parser receiving sentences from the sentence receiver and employing templates with associated partial parse trees which can be matched to sequences of both types of words and other grammatical elements.

There is yet further provided in accordance with another preferred embodiment of the present invention a parsing engine including an off-line grammar compiler and a parser which employs a pre-compiled grammar provided by the off-line grammar compiler.

There is still further provided in accordance with yet another preferred embodiment of the present invention a parsing method including receiving a sentence and parsing the sentence employing a pre-compiled grammar.

There is also provided in accordance with still another preferred embodiment of the present invention a parsing method including pre-compiling a grammar, not in real time, receiving a sentence subsequent to the pre-compiling and parsing at least part of the sentence, employing the grammar, to a matching set of sequences of types of words.

There is further provided in accordance with another preferred embodiment of the present invention a parsing method including receiving a sentence and parsing the sentence, employing syntactic templates and associated partial parse trees, by matching at least some of the syntactic templates to sequences of types of words.

There is still further provided in accordance with yet another preferred embodiment of the present invention a parsing method including receiving a sentence and parsing most complete sentences, up to a predetermined size, at a speed substantially faster than sentences exceeding the predetermined size.

There is also provided in accordance with still another preferred embodiment of the present invention a parsing method including receiving a sentence and parsing the sentence, employing syntactic templates and associated partial parse trees, by matching sequences of types of words of at least parts of the sentence.

There is further provided in accordance with another preferred embodiment of the present invention a parsing method including receiving a sentence and parsing, parts of the sentence, employing templates, with associated partial parse trees, which can be matched to sequences of types of words of at least the parts of the sentence, thereby enabling the parsing of parts of sentence at partial sentence parsing speeds greatly in excess of full sentence parsing speeds attainable when parsing the sentence as a fill sentence.

There is still further provided in accordance with yet another preferred embodiment of the present invention a parsing method including receiving a sentence and parsing the sentence by employing templates, with associated partial parse trees, which can be matched to sequences of both types of words and other grammatical elements.

There is also provided in accordance with still another preferred embodiment of the present invention a parsing method including compiling a grammar off-line and parsing, employing the grammar.

In accordance with another preferred embodiment, the parser provides enhanced speed parsing of complete sentences which can be matched to a single syntactic template. Preferably, at least a plurality of the syntactic templates with associated partial parse trees each include a sequence of types of words which can be directly matched to at least part of a sentence.

Preferably, each of the syntactic templates and associated partial parse trees corresponds to a phase domain element. Alternatively, at least some of the syntactic templates with associated partial parse trees include phase domain elements.

In accordance with another preferred embodiment, the parser provides enhanced speed parsing.

In accordance with yet another preferred embodiment, the pre-compiled grammar, includes a set of sequences of types of words which can be directly matched to at least part of a sentence. Preferably, the parser uses the partial parse trees to build new sentence representations. Additionally, the new sentence representations link the partial parse trees to their corresponding part of sentence.

In accordance with still another preferred embodiment, the phase domain elements in the syntactic templates match phase domain elements that are initial elements of the partial parse trees. Alternatively, the syntactic templates can be matched to parts of the new sentence representations. Additionally or alternatively, the syntactic templates are matched to parts of new sentence representations iteratively to produce a plurality of partial parse trees.

In accordance with yet another preferred embodiment, the parsing engine also includes a pre-parser operative to break down sentences received by the sentence receiver at least partially to types of words. Additionally or alternatively, the parsing engine also includes a post parser selecting an optimal parsed result from among a plurality of parsed results provided by the parser. Preferably, the post parser is operative to confirm syntactic agreement between elements in individual ones of the plurality of parsed results. Alternatively, the parser is operative to confirm syntactic agreement between elements during generation of the plurality of parsed results.

In accordance with another preferred embodiment, the parser operates generally in real time. Additionally or alternatively, the pre-parser operates generally in real time. Additionally or alternatively, the post-parser operates generally in real time.

Preferably, the parser operates substantially without non-grammar based processing of a sentence. Additionally, the pre-compiled grammar is modular.

In accordance with still another preferred embodiment, the parsing engine also includes a speech recognizer receiving speech and providing a sentence output to the sentence receiver. Additionally, the speech recognizer also employs the pre-compiled grammar. Alternatively, the speech recognizer employs the pre-compiled grammar in a form which is pre-compiled not in real time to a set of sequences of phonemes.

In accordance with another preferred embodiment, the pre-parser is operative to provide at least one sentence representation. Preferably, the at least one sentence representation is generated by looking up word stems in a modular word dictionary, in order to obtain the corresponding types of words. Additionally, the at least one sentence representation employs at least one one-word partial parse tree for each word.

In accordance with yet another preferred embodiment, the pre-compiled grammar is included of a multiplicity of tree constructs. Preferably, the tree constructs are linked collections of grammatical elements. Additionally, the linked collections of grammatical elements include at least one of a bifurcated element, an initial element, a phase domain element and a non-bifurcated element, and are characterized by at least one of the following: 1) each bifurcated element represents a selectional restriction in the grammar, 2) the initial element is a phase domain element, as known in linguistics, 3) other than the initial element, no phase domain element is bifurcated and 4) all non-bifurcated elements are either phase domains, words or empty category elements, as known in linguistics.

Preferably, the tree constructs include decomposition of a language element into other language elements or word types.

In accordance with another preferred embodiment, the pre-compiled grammar employs the tree constructs to generate a plurality of syntactic templates and associated partial parse trees. Preferably, the syntactic templates and associated partial parse trees are stored in a syntactic template database. Additionally, the syntactic templates are sequences of at least one of types of words and phase domain elements derived from combinations of tree constructs defined by the grammar.

Preferably, each combination of tree constructs potentially provides a separate syntactic template and associated partial parse tree.

In accordance with a preferred embodiment, the parser employs a top-down algorithm to generate the syntactic templates and associated partial parse trees. Additionally or alternatively, the parser employs a bottom-up algorithm to generate the syntactic templates and associated partial parse trees.

Preferably, a plurality of trees is created from each tree construct. Additionally, each tree of the plurality of trees is created by attaching to each unbifurcated phase domain element of a tree construct, a matching tree construct, being a different tree construct whose initial element is identical to the unbifurcated element. Alternatively, the parsing engine also includes attaching a different matching tree construct to each unbifurcated phase domain element of each resulting tree, thereby providing a plurality of trees whose number of non-empty unbifurcated elements is less than a predetermined threshold value.

Preferably, the plurality of trees includes all possible trees.

In accordance with another preferred embodiment, the syntactic templates correspond to a sequence of non-empty unbifurcated elements in the tree. Preferably, each sequence is created by reading the non-empty unbifurcated elements along the underside of the tree from left to right. Preferably, the tree is stored with the syntactic template as its associated partial parse tree.

Preferably, the parser initially attempts to match an entire sentence representation, and failing that, attempts to match at least one most appropriate subdivision thereof, to syntactic templates stored in a syntactic template database. Preferably, the at least one most appropriate subdivision is the largest possible subdivision. Additionally, the matched syntactic templates are employed to define a partial parse tree.

In accordance with a preferred embodiment, time is of the essence in the parsing.

In accordance with yet another preferred embodiment, the parser creates memory objects representing possible sub-sequences of a sentence representation. Preferably. the possible sub-sequences include all possible sub-sequences. Additionally, the sub-sequences are arranged in a pyramidal structure. Preferably, the base of the pyramid includes memory objects representing single-element subsequences.

Preferably, the creation of the memory objects takes place based on addition of an element to a previously created object having all but one of the same elements.

In accordance with still another preferred embodiment a hash value is assigned to each memory object. Preferably, each multiple-element object is assigned a hash value based on the hash value of a previously created object having all but one of the same elements and the element added to that previously. created object. Additionally, the relationship between hash values of the memory objects is expressed as follows:

HASH (MULTI-ELEMENT OBJECT)=COMB (HASH (PREVIOUSLY CREATED OBJECT), ADDED ELEMENT)

Preferably, the hash value of at least one memory object is employed to search the syntactic template database for a match between the subsequence represented by tile at least one memory object and a syntactic template containing the same subsequence.

In accordance with another preferred embodiment, the parser selects a sentence subsequence, having a matched syntactic template, for further processing. Preferably, the parser selects the longest sentence subsequence. Alternatively, the parser selects the sentence subsequence which is closest to the tip of the pyramid. Additionally or alternatively, the parser selects the sentence subsequence including the longest noun phrase. Alternatively, the parser selects the sentence subsequence containing a noun phrase which is closest to the tip of the pyramid. In accordance with yet another preferred embodiment, the parser selects a sentence subsequence in accordance with the heuristic philosophy Governing the implementation of parsing in a given embodiment.

Preferably, the parser selects a sentence subsequence and resolves it into a corresponding partial parse tree. Additionally, the parser creates a new sentence representation by replacing the sentence subsequence with the corresponding partial parse tree. Preferably, the new sentence representation is linguistically equivalent to the sentence representation.

In accordance with still another preferred embodiment, an initial selection of the sentence subsequence for further processing is non-deterministic. Preferably, the parser creates new memory objects, having the same properties as the memory objects, from the new sentence representation. Additionally, the parser selects a memory object for further processing from all memory objects and not merely the most recently created memory objects.

In accordance with another preferred embodiment, the parser eliminates parse trees having syntactic agreement mismatches. Preferably, the syntactic agreement mismatches include singular/plural mismatches. Additionally, the syntactic agreement mismatches include masculine/feminine mismatches. Alternatively or additionally, the syntactic agreement mismatches include grammatical case mismatches. Additionally, the syntactic agreement mismatches include person mismatches. Alternatively, the syntactic agreement mismatches include definiteness mismatches.

In accordance with yet another preferred embodiment, some syntactic features of at least one pair of grammatical elements in the parse trees undergo unification. Preferably, the at least one pair of grammatical elements is a mother-daughter pairs of elements. Additionally or alternatively, the at least one pair of grammatical elements is a probe-goal pair of elements.

In accordance with yet another preferred embodiment at least a portion of the parser is included on an integrated circuit chip.

### BRIEF DESCRIPTION OF THE DRAWINGS

The present invention will be understood and appreciated more fully from the following detailed description, taken in conjunction with the drawings in which:

FIG. 1 is a simplified symbolic illustration of the operation of a parsing engine in accordance with a preferred embodiment of the present invention;

FIG. 2 is a simplified symbolic illustration illustrating various steps in parsing functionality operative in accordance with a preferred embodiment of the present invention;

FIG. 3 is a simplified illustration of a preferred embodiment of pre-parsing employed in accordance with a preferred embodiment of the present invention;

FIG. 4 is a simplified illustration of use of a grammar in accordance with a preferred embodiment of the present invention;

FIGS. 5A, 5B and 5C are simplified illustrations of language grammar compilation employed in accordance with a preferred embodiment of the present inventions

FIGS. 6A and 6B are simplified illustrations of respective top-down and bottom-up algorithms useful in the compilations illustrated in FIGS. 5A-5C;

FIG. 7 is a simplified illustration of construction of syntactic templates following the compilation shown in FIGS. 5A-6B;

FIG. 8 is a simplified illustration of the use of syntactic templates in parsing in accordance with a preferred embodiment of the present invention;

FIG. 9 is a simplified illustration of the use of syntactic templates when an entire sentence is covered by a syntactic template;

FIG. 10 is a simplified illustration of the use of syntactic templates when an entire sentence is not covered by a syntactic template, but multiple templates are required to cover the sentence;

FIGS. 11A and 11B are simplified illustrations of initial steps in an algorithm for parsing, sentences using multiple syntactic templates in accordance with a preferred embodiment of the present invention;

FIG. 12 is a simplified illustration of a further step in an algorithm for parsing sentences using multiple syntactic templates in accordance with a preferred embodiment of the present invention;

FIGS. 13A and 13B are simplified illustrations of still further steps in an algorithm for parsing sentences using multiple syntactic templates in accordance with a preferred embodiment of the present invention;

FIGS. 14A, 14B, 14C and 14D are simplified illustrations of yet further steps in an algorithm for parsing sentences using multiple syntactic templates in accordance with a preferred embodiment of the present invention;

FIG. 15 is a simplified illustration of additional steps in an algorithm for parsing sentences using multiple syntactic templates in accordance with a preferred embodiment of the present invention;

FIG. 16 is a simplified illustration of iteration in an algorithm for parsing sentences using multiple syntactic templates in accordance with a preferred embodiment of the present invention;

FIGS. 17A and 17B are simplified illustrations of the conclusion of iterative parsing using multiple syntactic templates in accordance with a preferred embodiment of the present invention, producing two possible types of results;

FIGS. 18A and 18B are simplified illustrations of two possible types of results of the parsing of FIGS. 17A and 17B, respectively, in accordance with a preferred embodiment of the present invention;

FIG. 19 is a simplified illustration of harvesting multiple parse trees produced by interactive parsing in accordance with a preferred embodiment of the present invention;

FIGS. 20A and 20B are simplified illustrations of parse tree consistency checking, preferably employed in accordance with a preferred embodiment of the present invention;

FIGS. 21A, 21B and 21C are simplified symbolic illustrations of various embodiments of the present invention, where portions of the parsing engine are included on an integrated circuit chip; and

FIG. 22 is a simplified symbolic illustration of yet another preferred embodiment of the present invention, where the parsing engine also includes a speech recognition engine.

### DETAILED DESCRIPTION OF PREFERRED EMBODIMENTS

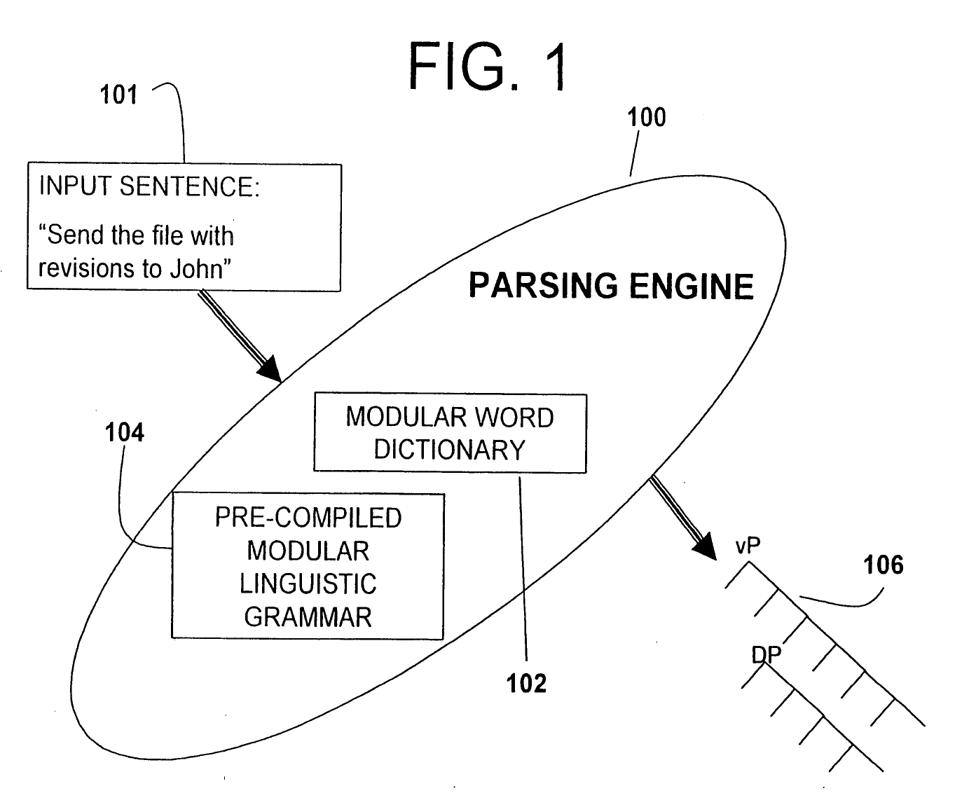

Reference is now made to FIG. 1, which is a simplified symbolic illustration of the operation of a parsing engine in accordance with a preferred embodiment of the present invention. As seen in FIG. 1, a parsing engine 100 receives an input sentence 101, typically “Send the file with revisions to John”. The input sentence 101 may be received by the parsing engine 100 via any suitable input interface, such as, for example, a text input interface or a speech input interface. It is appreciated that input sentence 101 may comprise a grammatically complete sentence or any suitable sequence of words to be parsed.

In accordance with a preferred embodiment of the present invention, the parsing engine 100 comprises at least one modular word dictionary 102 which cooperates with at least one pre-compiled modular linguistic grammar 104.

The parsing engine 100 preferably provides an output in the form of a parse tree 106, which represents the input sentence 101. In the illustrated embodiment of FIG. 1, the parse tree 106 is seen to include a full light verb phrase, designated vP, which contains, inter alia, a noun phrase, normally termed a full determiner phrase and designated DP.

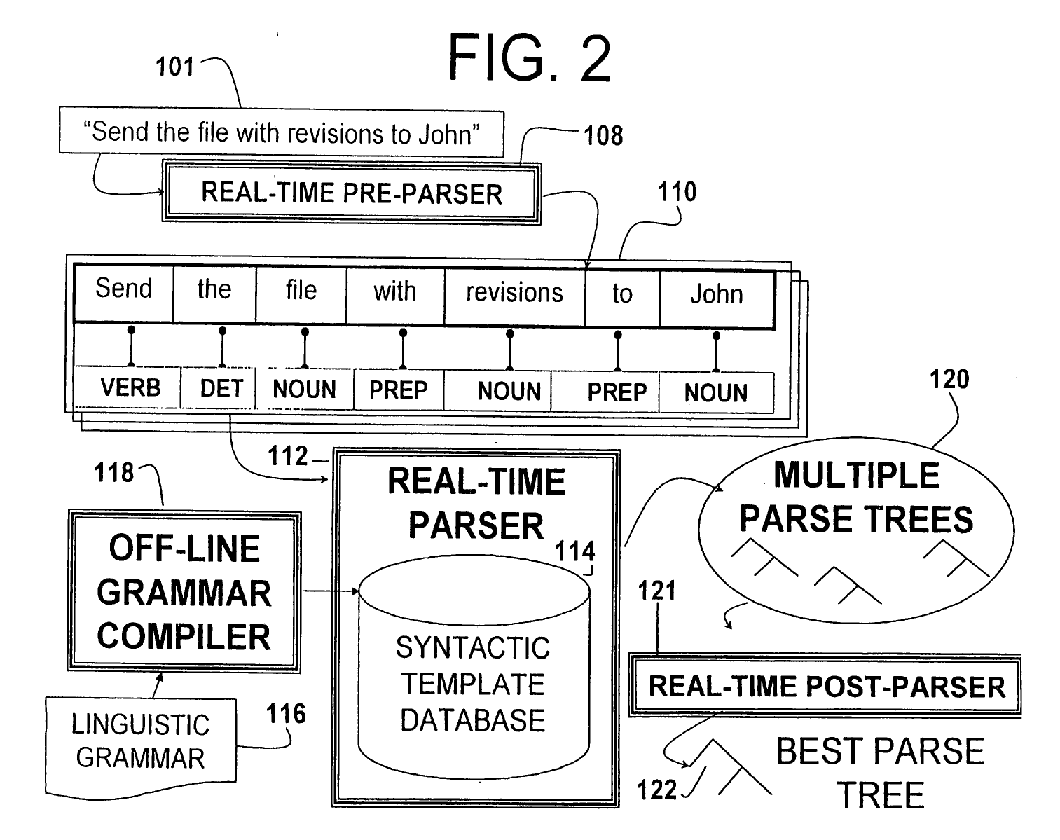

Reference is now made to FIG. 2, which is a simplified symbolic illustration illustrating, various steps in parsing functionality operative in accordance with a preferred embodiment of the present invention in the parsing engine 100 of FIG. 1.

As seen in FIG. 2, the input sentence 101 “Send the file with revisions to John” undergoes a real-time pre-parsing operation, wherein a real-time pre-parser 108 breaks the input sentence 101 into at least one sentence representation, preferably in the form of a sequence of single element parse trees, one of which sequences is shown in FIG. 2 and designated by reference numeral 110.

A real-time parser 112 receives the sentence representations and employs a syntactic template database 114 for real-time parsing of the sentence representations. It is a particular feature of the present invention that the real-time parser employs a pre-compiled form of a linguistic grammar 116, preferably a modular linguistic grammar. Compilation of the linguistic grammar is preferably effected off-line by a compiler 118, prior to receipt of the input sentence 101. This greatly reduces the computing power and time required for parsing.

The real-time parser 112 typically provides multiple parse trees 120, which are subject to a real-time post-parsing operation, in which real-time post-parser 121 preferably chooses the best parse tree 122 from among the multiple parse trees 120.

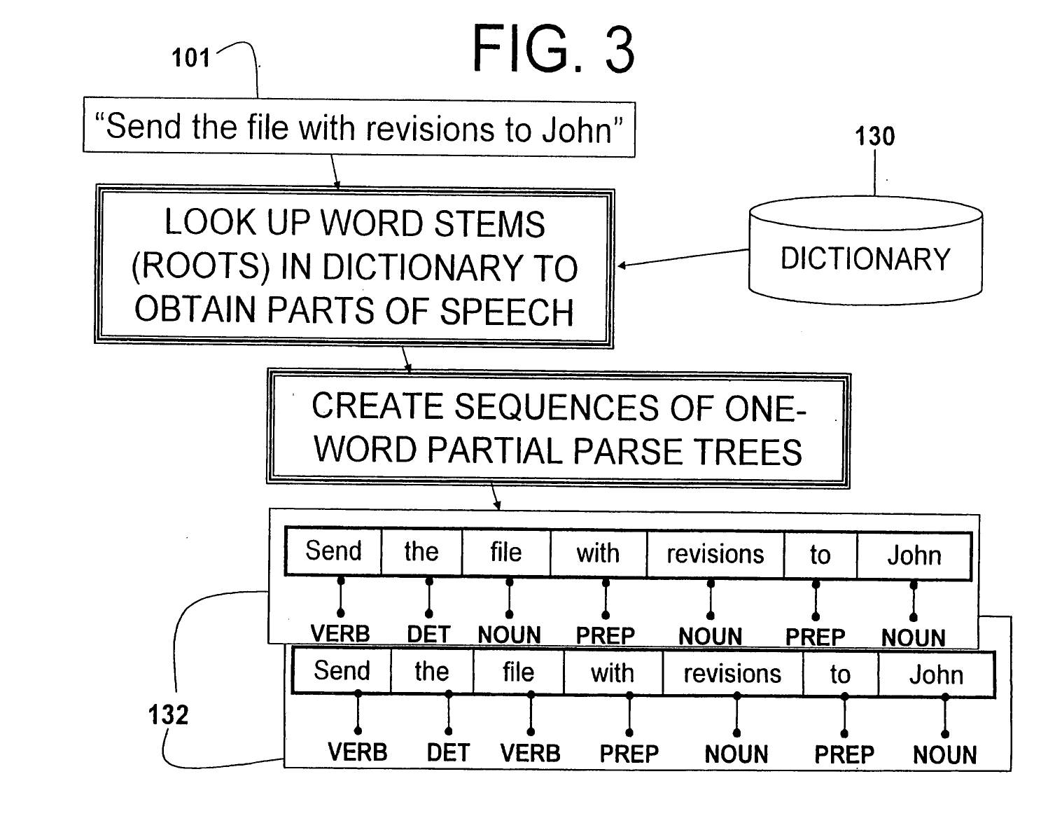

Reference is now made to FIG. 3, which is a simplified illustration of a preferred embodiment of pre-parsing employed in accordance with a preferred embodiment of the present invention. As seen in FIG. 3, the input sentence 101, “Send the file with revisions to John” is operated upon by looking up word stems in a dictionary 130, preferably the modular word dictionary 102 of FIG. 1, in order to obtain the corresponding types of words. The types of words may comprise any suitable type of word or part of speech as commonly known, or any other lexically recognizable item.

At least one one-word partial parse tree is created for each word, thereby providing at least one sentence representation 132, which is typically identical to sentence representation 110 of FIG. 2.

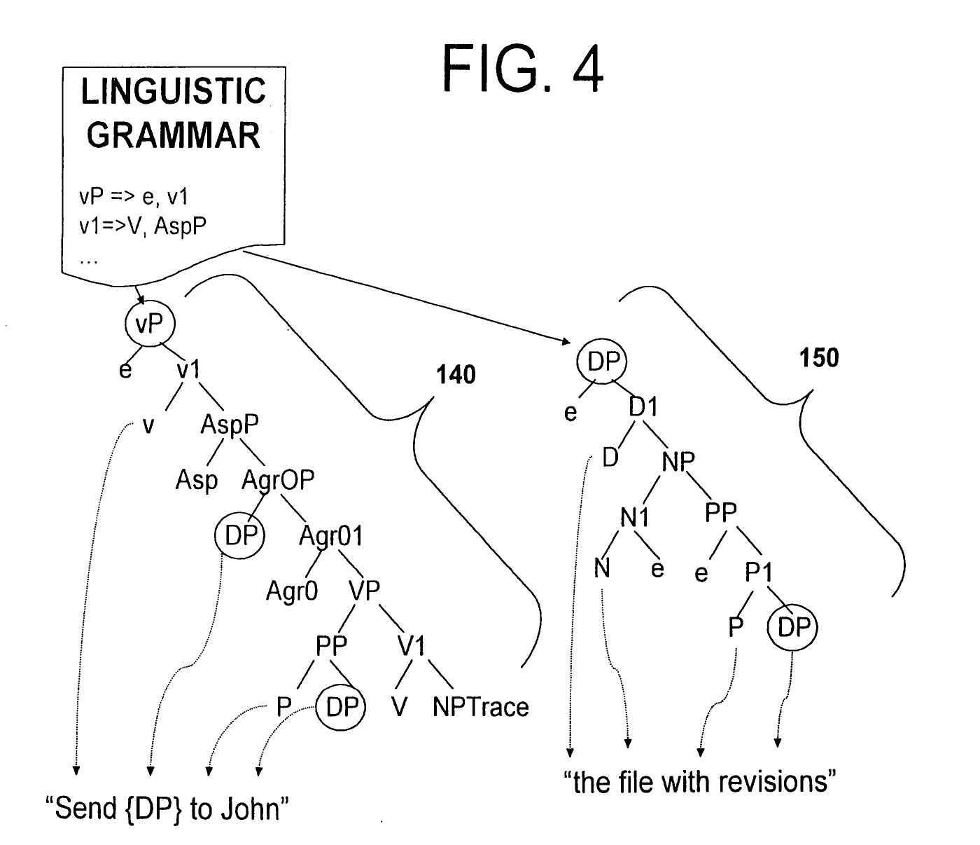

Reference is now made to FIG. 4, which is a simplified illustration of the use or a linguistic grammar in accordance with a preferred embodiment of the present invention to produce tree constructs. Tree constructs are defined for the present purposes as linked collections of grammatical elements in which:

1. each bifurcated element reflects, as known in the field of linguistics, a selectional restriction in the grammar imposed by the type of the bifurcated element. These selectional restrictions are shown in FIG. 4 as lines in the grammar indicating pairs of elements into which an element can be bifurcated;

2. the initial element is a phase domain element, as known in linguistics;

3. other than the initial element, no phase domain element is bifurcated; and

4. all non-bifurcated elements are either phase domains, words or empty category elements, as known in linguistics.

Such tree constructs are a particular feature of the present invention. Preferably, the linguistic grammar may generate hundreds of tree constructs, represented by parse trees, illustrating decomposition of a language construct, such as a phrase, into other language constructs or words.

As seen in FIG. 4, a tree construct for a full light verb phrase, here designated vP, may be represented by a tree construct 140, which typically includes a phase domain vP which is bifurcated into an empty category element, designated e, and a small light verb phrase designated v1. v1 is in turn bifurcated into a light verb, designated v, here “Send”, and a full internal aspect phrase designated AspP. AspP is bifurcated into an internal aspect head, designated Asp and a full object agreement phrase designated AgrOP.

AgrOP is bifurcated into a small object agreement phrase Agr01 and a full determiner phrase, designated DP, which is a phase domain element. Agr01 is bifurcated into an object agreement head AgrO and a full lexical verb phrase, designated VP. VP is bifurcated into a full prepositional phrase, designated PP and a small lexical verb phrase V1. PP is bifurcated into a preposition, designated P, here “to”, and a full determiner phrase, DP, here “John”. V1 is bifurcated into a lexical verb V and into an empty category NPTrace, associated with a full determiner phrase, DP, higher in the tree.

A tree constructed for a full determiner phrase, here designated DP, which may, later in the parsing process, be equated with one of the DPs in tree construct 140, may be represented by a tree construct 150, which typically includes a phase domain DP, which is bifurcated into an empty category element, e, and a small determiner phrase, designated D1. D1 is bifurcated into a determiner head, designated D, here “the”, and a full lexical noun phrase, here designated NP. NP is bifurcated into a small lexical noun phrase, here designated N1, and a full prepositional phrase, here designated PP. N1 is bifurcated into a lexical noun, designated N, here “file”, and an empty category element, e. PP is bifurcated into an empty category element, e, and a small prepositional phrase P1. P1 is bifurcated into a preposition, here designated P, here “with”, and a full determiner phrase, DP, here “revisions”.

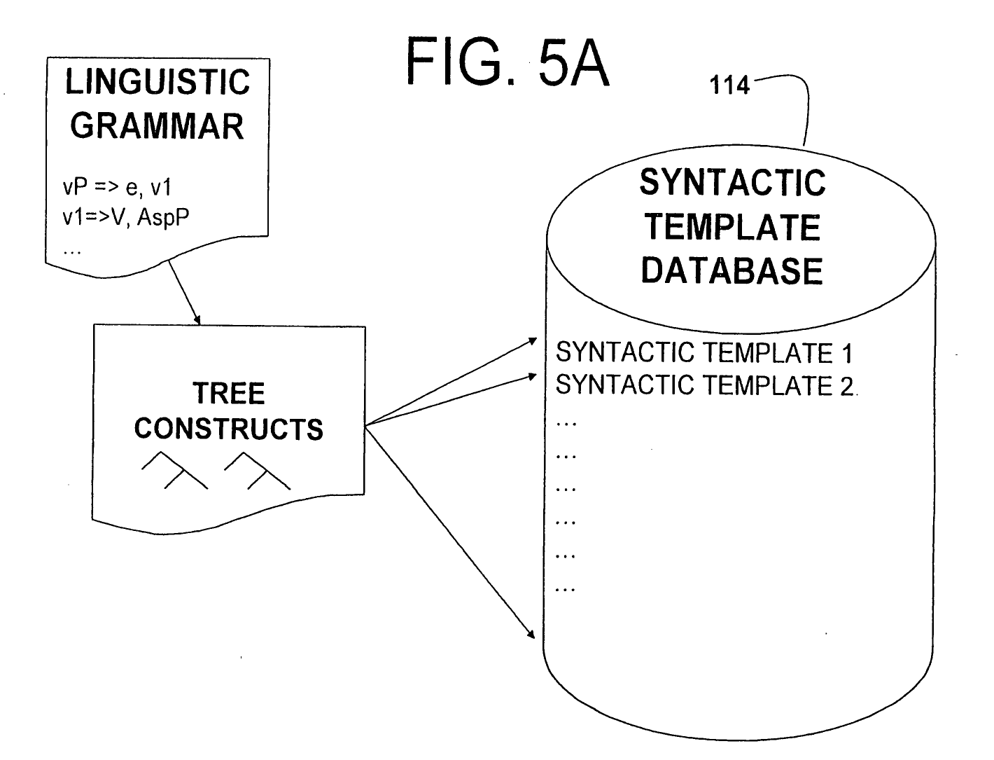

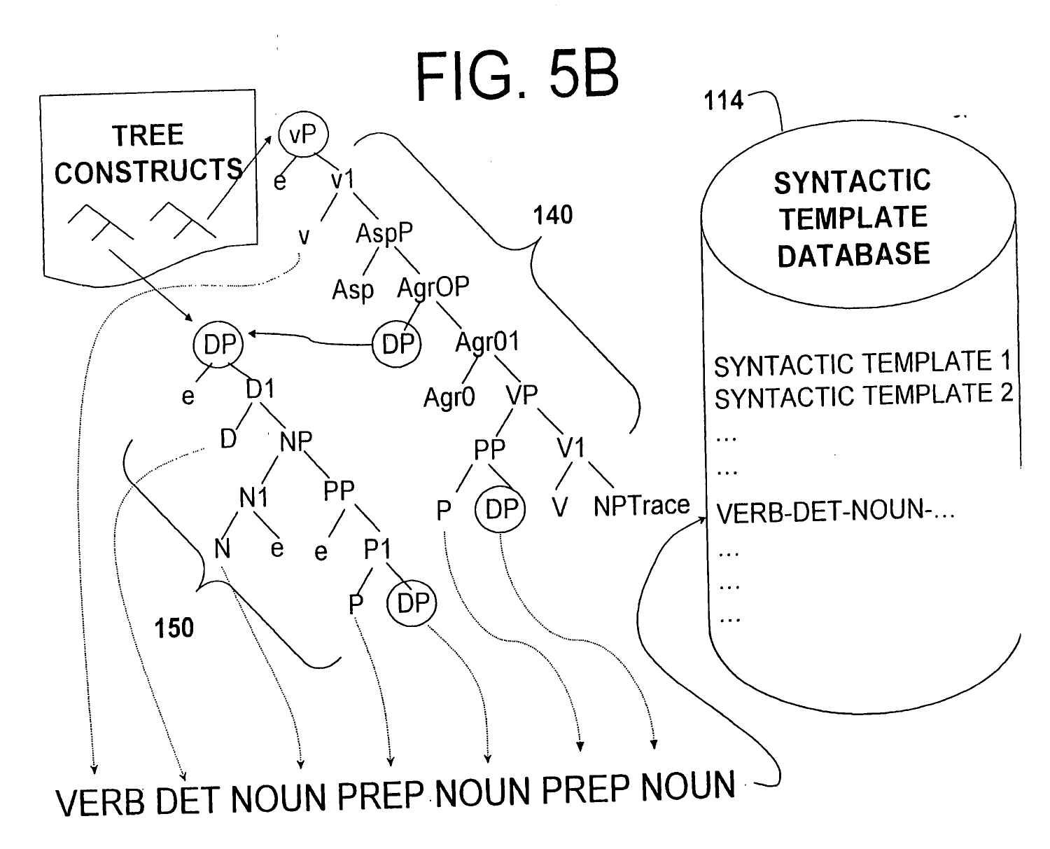

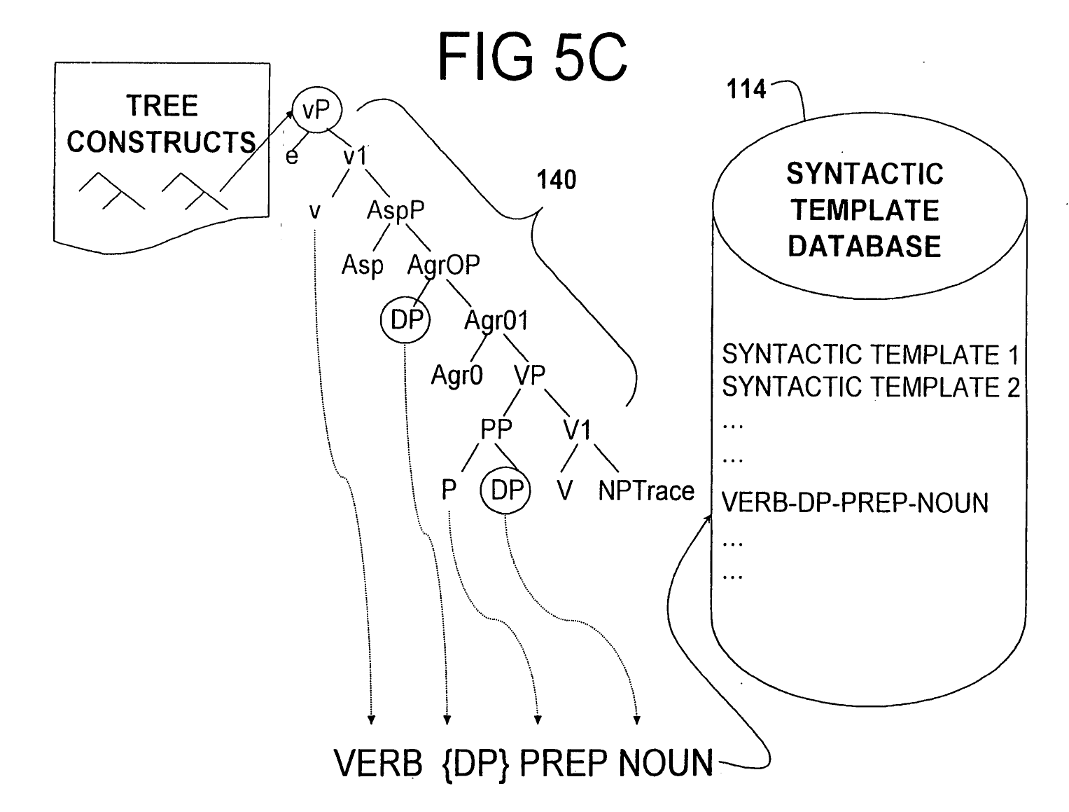

Reference is now made FIGS. 5A, 5B and 5C, which are simplified illustrations of language grammar compilation employed in accordance with a preferred embodiment of the present invention. As seen in FIG. 5A, compilation of the linguistic grammar employs the tree constructs to produce a series of syntactic templates and associated partial parse trees, which are stored in a syntactic template database 114, asshown in FIG. 2. The syntactic templates are preferably sequences of types of words and/or phase domain elements derived from combinations of tree constructs defined by the grammar. It is appreciated that the syntactic templates may also be comprised of any suitable sequences, such as sequences of phonemes.

FIG. 5B illustrates a derivation of syntactic templates from combinations of tree constructs defined by the grammar. Each combination of tree constructs potentially provides a separate syntactic template. Thus, as seen in FIG. 5B, tree constructs 140 and 150 from FIG. 4, respectively representing a full light verb phrase and a full determiner phrase, produce a syntactic template including a sequence of types of words, here VERB-DET-NOUN-PREP-NOUN-PREP-NOUN.

FIG. 5C illustrates a derivation of syntactic templates from a single tree construct defined by the grammar. As seen in FIG. 5C, tree construct 140 from FIG. 4, representing a full light verb phrase, produces a syntactic template including a sequence of types of elements, here VERB-DP-PREP-NOUN.

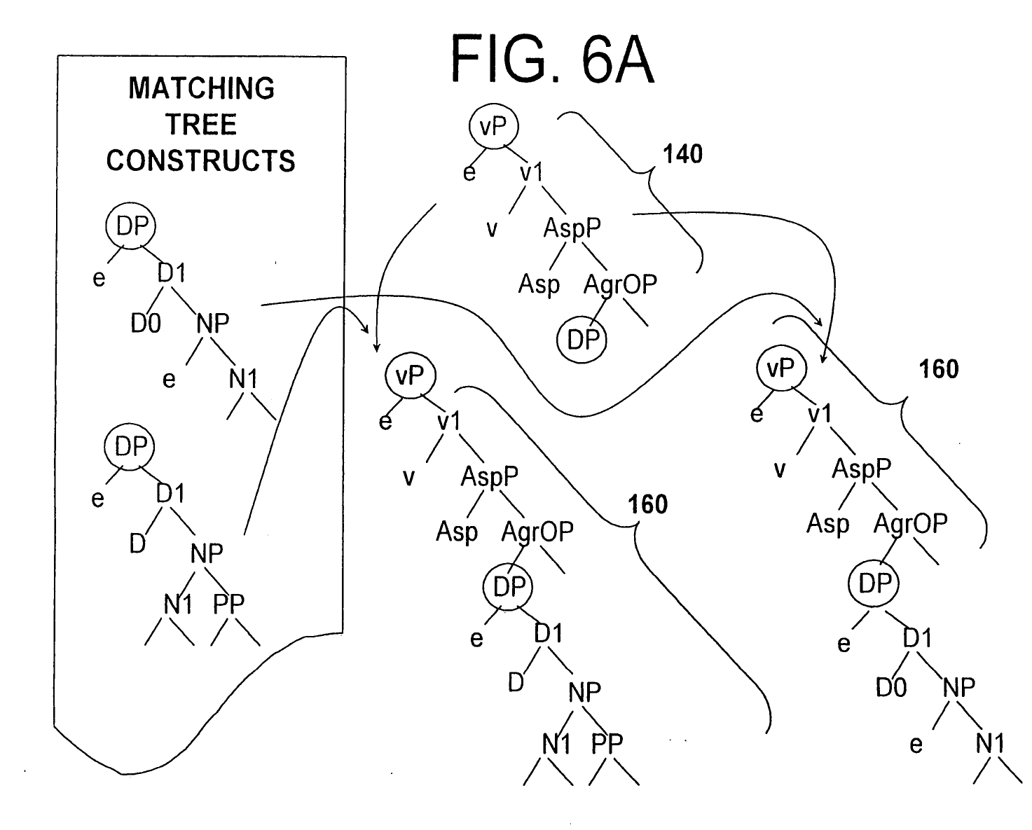

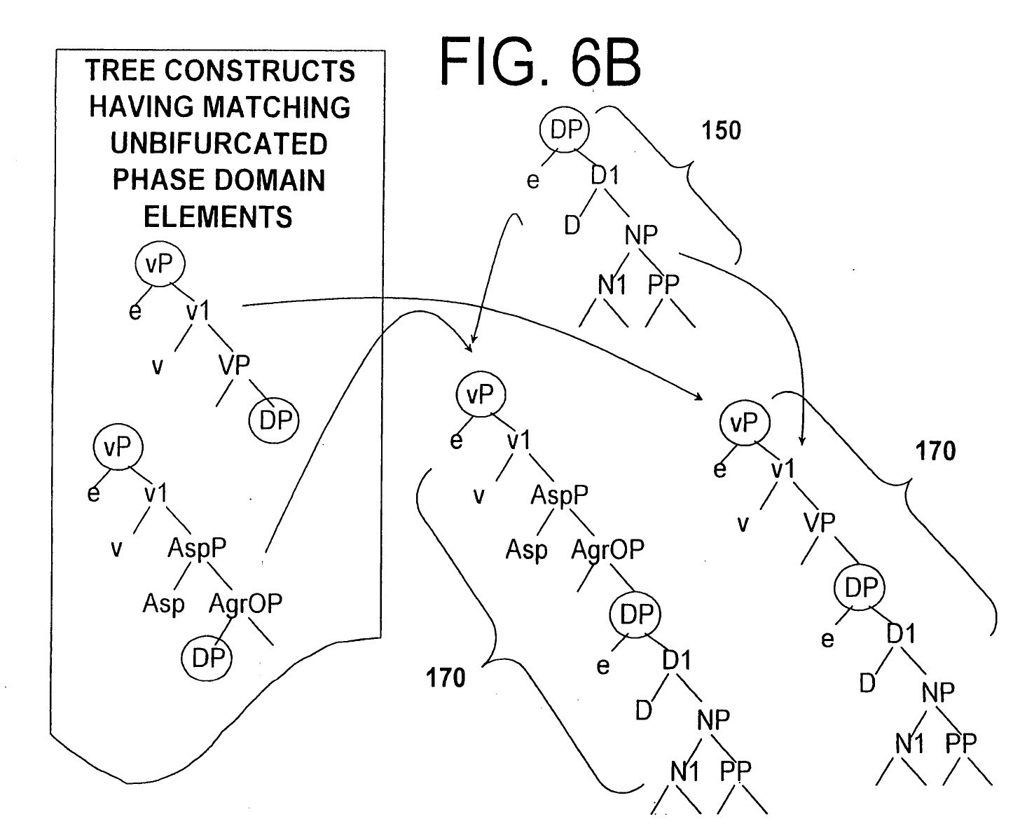

Reference is now made to FIGS. 6A and 6B, which are simplified illustrations of respective top-down and bottom-up algorithms useful in the compilations illustrated in FIGS. 5A and 5B. As seen in FIG. 6A, a plurality of trees 160 are created from each tree construct, such as the tree construct 140 of FIG. 4, which is shown in truncated form in FIG. 6A.

Each tree is created by attaching to each unbifurcated phase domain element of a tree construct, a different tree construct whose initial element is identical to the unbifurcated element, here termed a “matching tree construct”.

This process creates many trees. FIG. 6A shows only two such trees, which are formed from the same tree construct vP by attaching two different matching tree constructs to the same unbifurcated phase domain element DP.

The process continues by attaching to each unbifurcated phase domain element of each resulting tree, a different matching tree construct. The process creates all possible trees whose number of non-empty unbifurcated elements is less than a predetermined threshold value.

As seen in FIG. 6B, a plurality of trees 170 are created from each tree construct, such as the tree construct 150 of FIG. 4, which is shown in truncated form in FIG. 6B.

Each tree is created by attaching each tree construct to each unbifurcated phase domain element of another tree construct, here termed a “tree construct having a marching unbifurcated phase domain element”, which is characterized in that it has an unbifurcated phase domain element which is identical to the initial element of such tree construct.

This process creates many trees FIG. 6B shows only two such trees, which are formed from the same tree construct DP by attaching it to two different tree constructs vP having matching unbifurcated phase domain elements DP.

The process continues by attaching each resulting tree to each matching unbifurcated phase domain element of a tree construct. The process creates all possible trees whose number of non-empty unbifurcated elements is less than a predetermined threshold value.

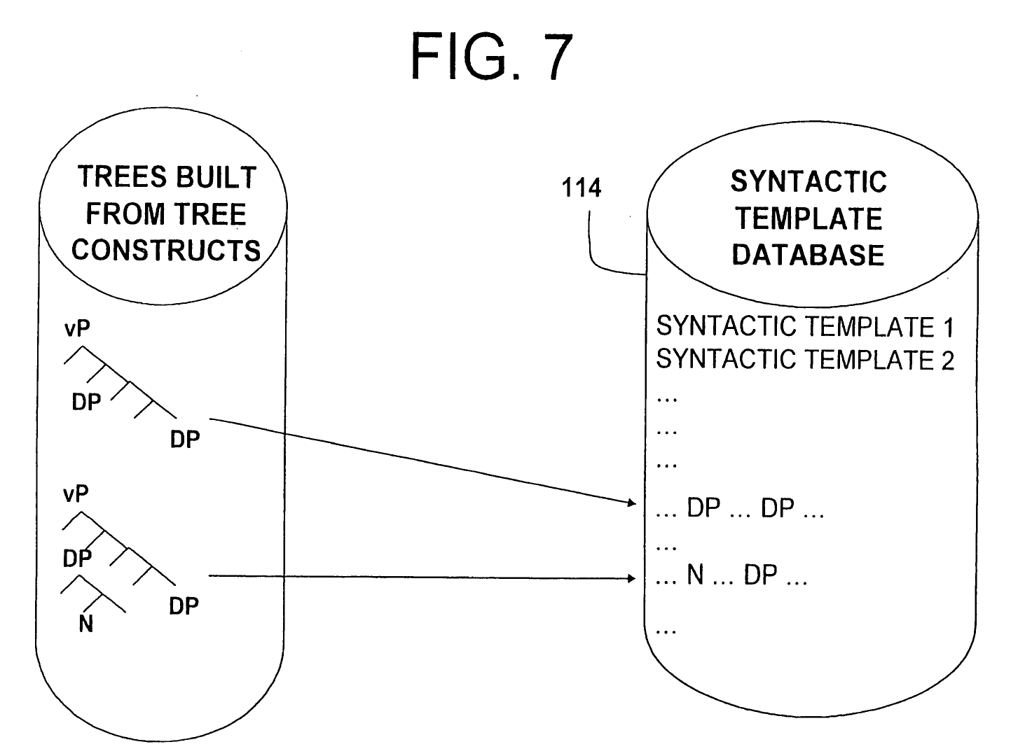

Reference is now made to FIG. 7, which is a simplified illustration of construction of syntactic templates following the compilation shown in FIGS. 5A-6B. As seen in FIG. 7, each syntactic template corresponds to a sequence of non-empty unbifurcated elements in a tree created by the process illustrated in either of FIGS. 6A and 6B. Normally the sequence is created by reading the non-empty unbifurcated elements alone the underside of the tree from left to right.

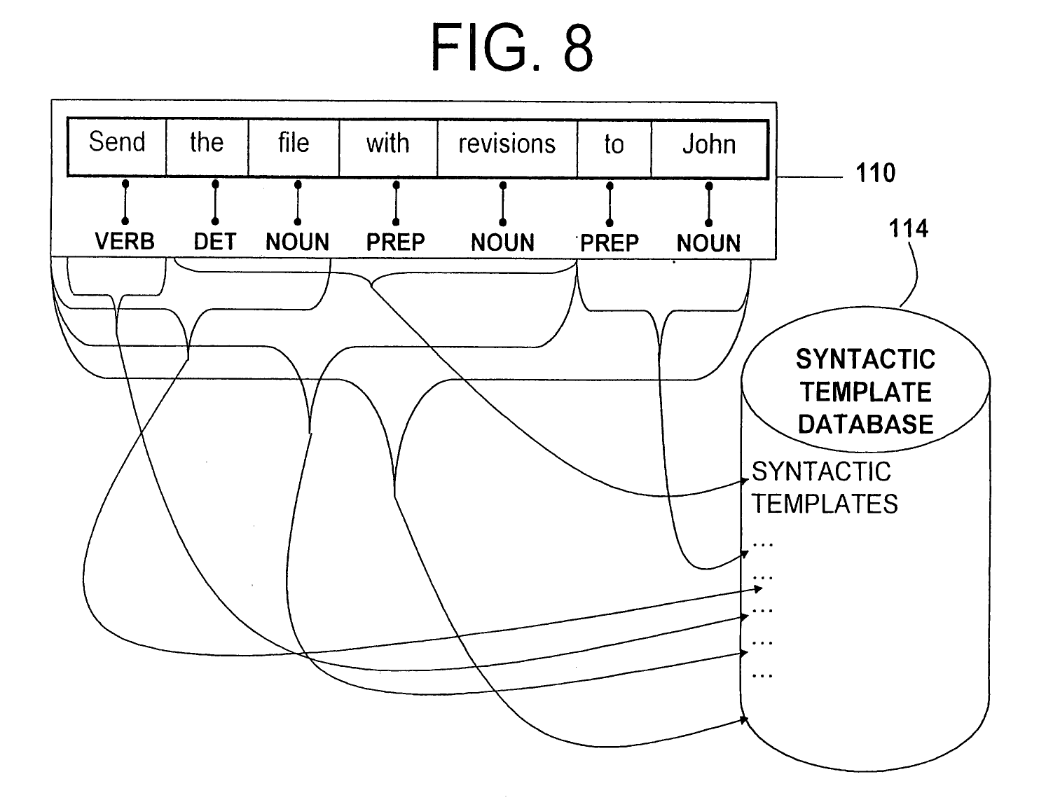

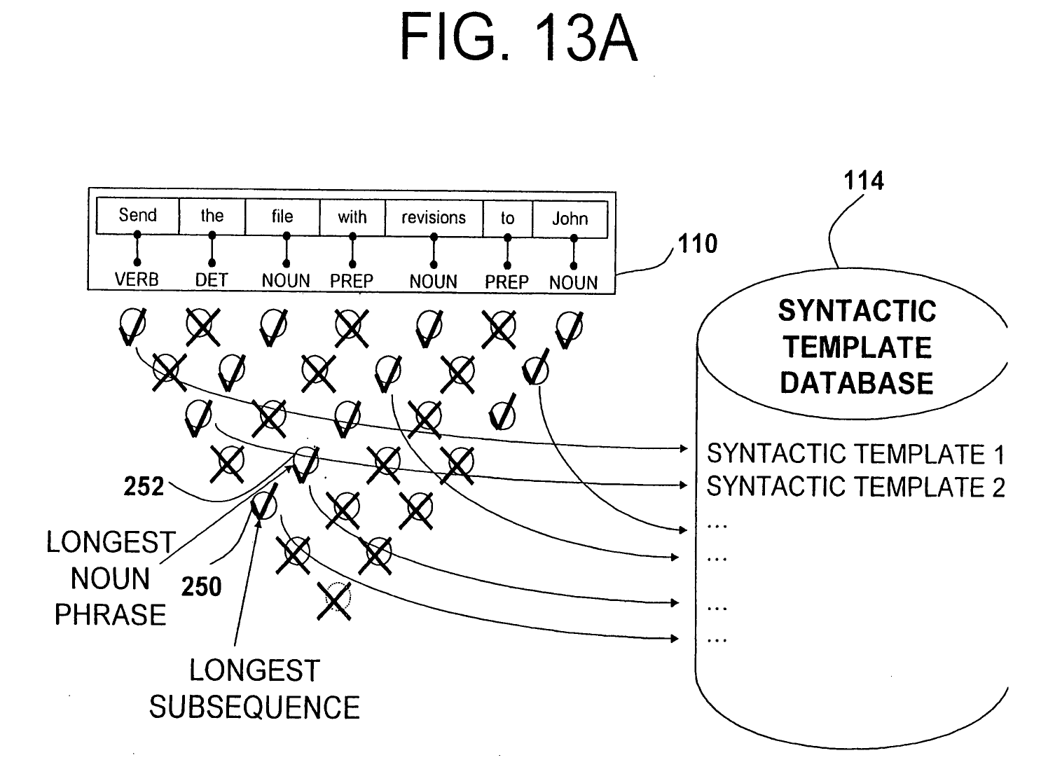

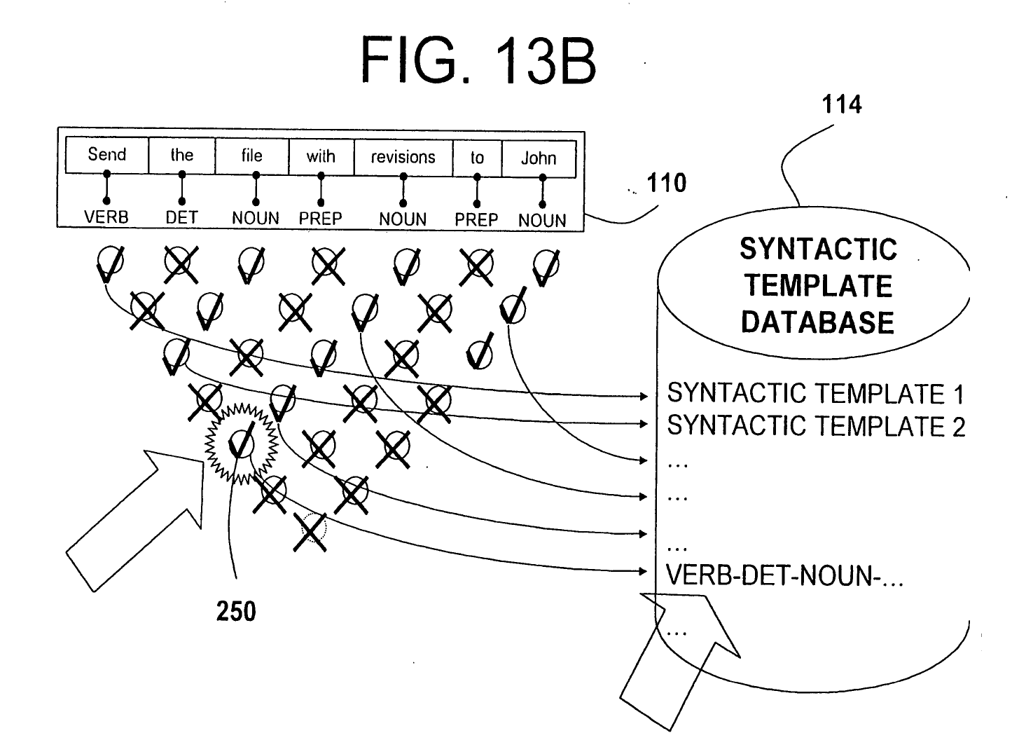

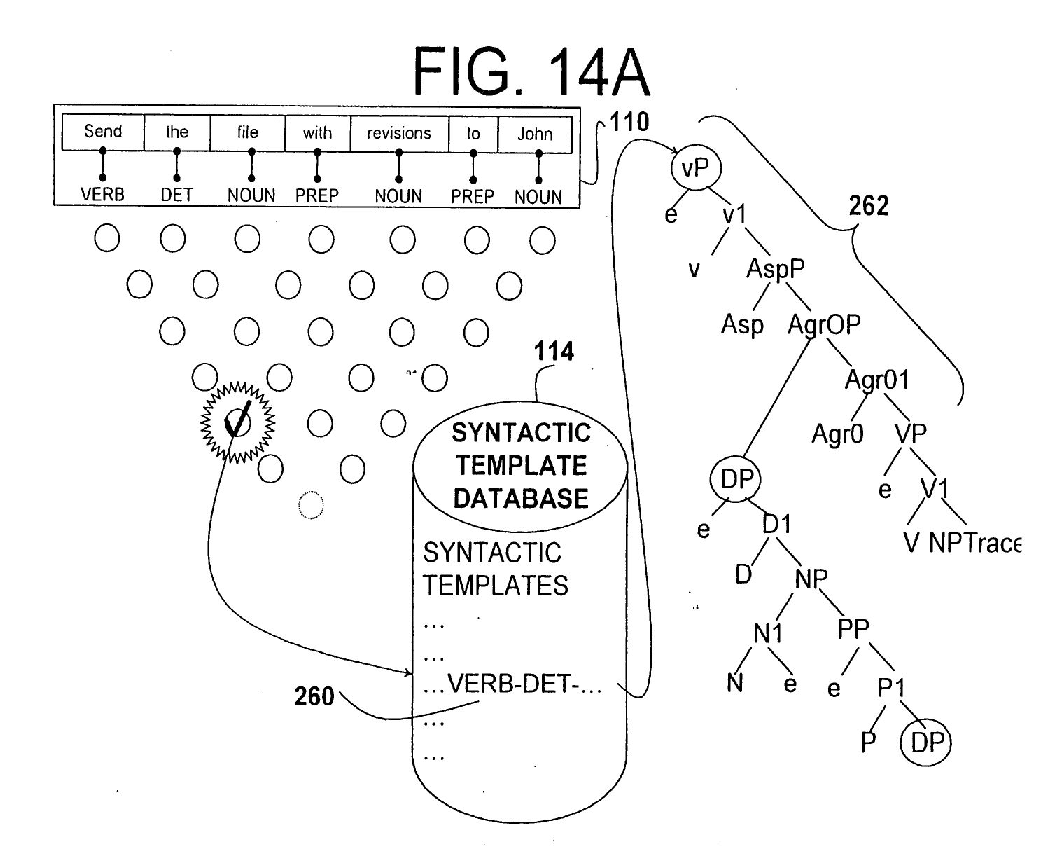

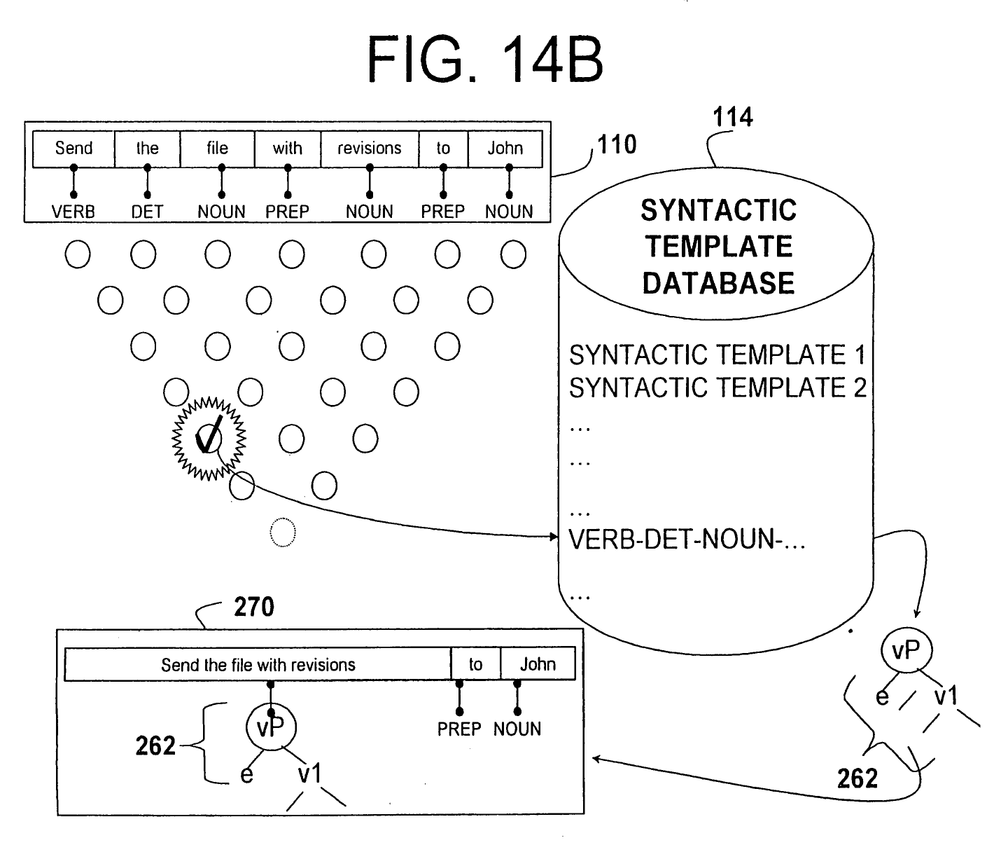

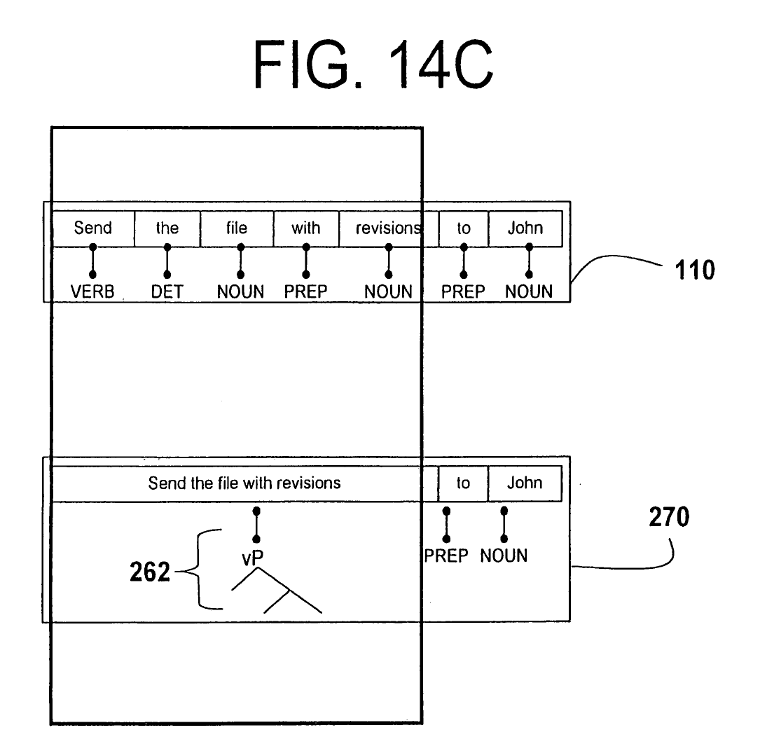

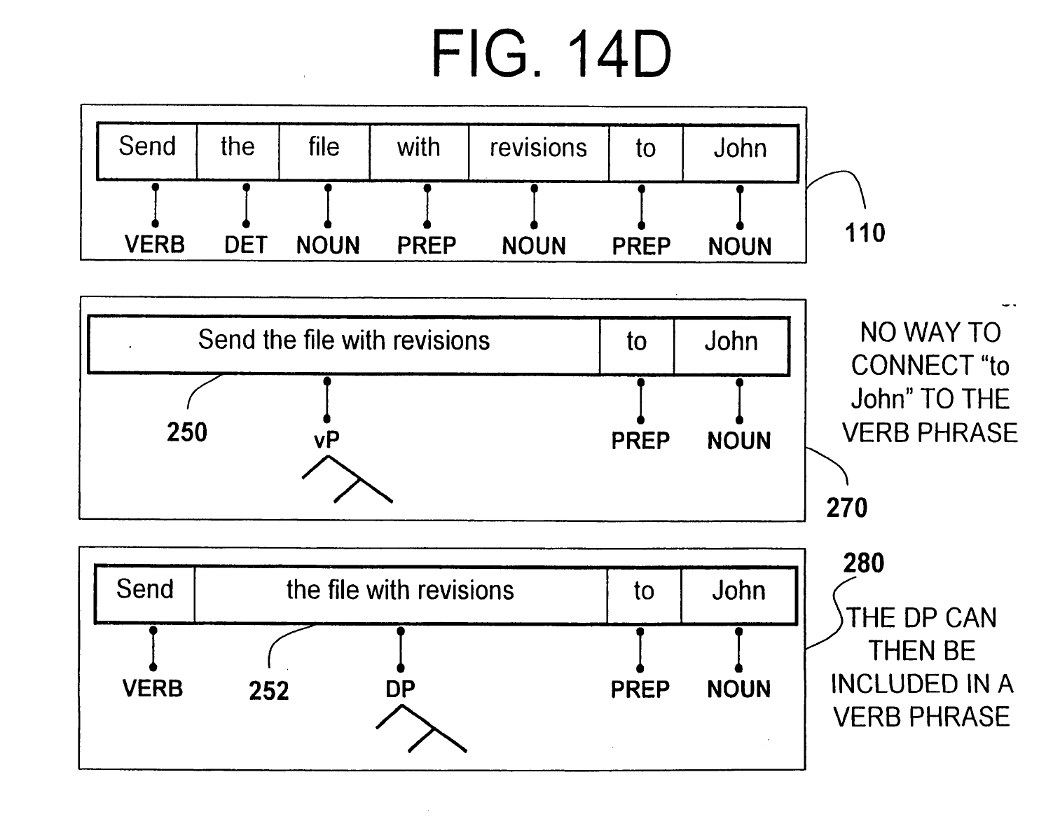

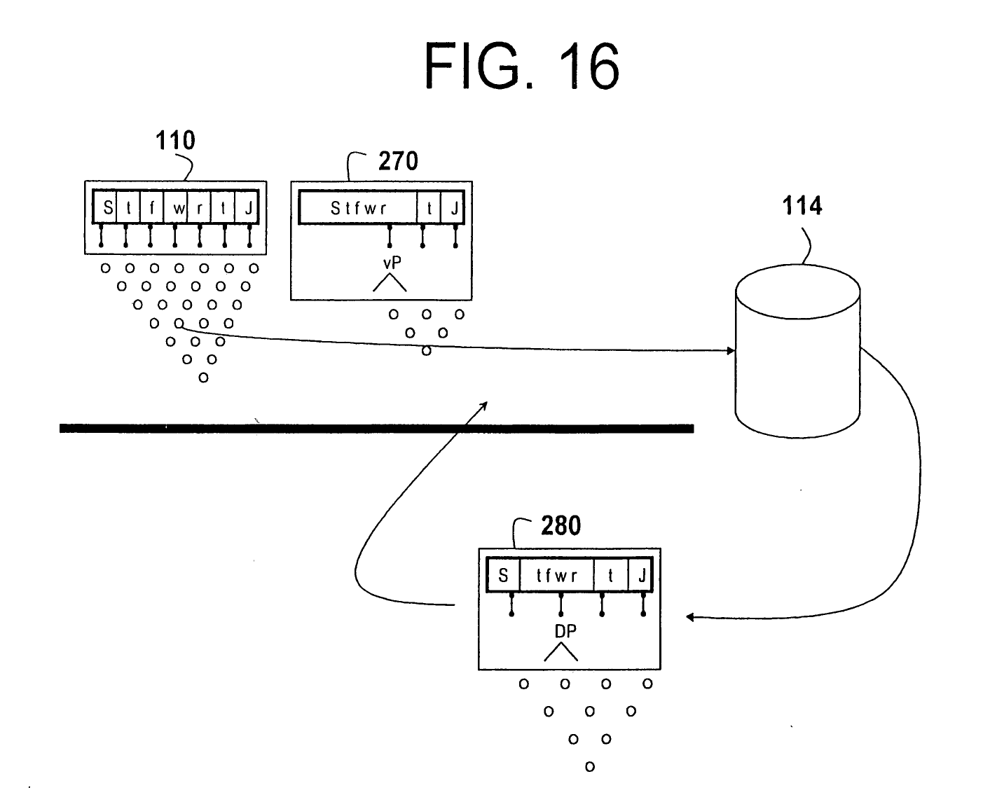

Reference is now made to FIG. 8, which is a simplified illustration of the use of syntactic templates in parsing in accordance with a preferred embodiment of the present invention. As seen in FIG. 8, the parsing engine of the present invention seeks to match the entire sentence representation 110 of FIG. 2, and failing that, the most appropriate subdivisions thereof, to syntactic templates stored in the syntactic template database. In certain cases the most appropriate subdivisions are the largest possible subdivisions, but this is not necessarily the case, as will be described hereinbelow with reference to FIGS. 13A and 13B. The most successfully matched syntactic templates are then used to define a parse tree, as shown in FIGS. 14B and 16.

It is appreciated that time is of the essence in the matching of FIG. 8, inasmuch as large numbers of syntactic templates are present in the syntactic template

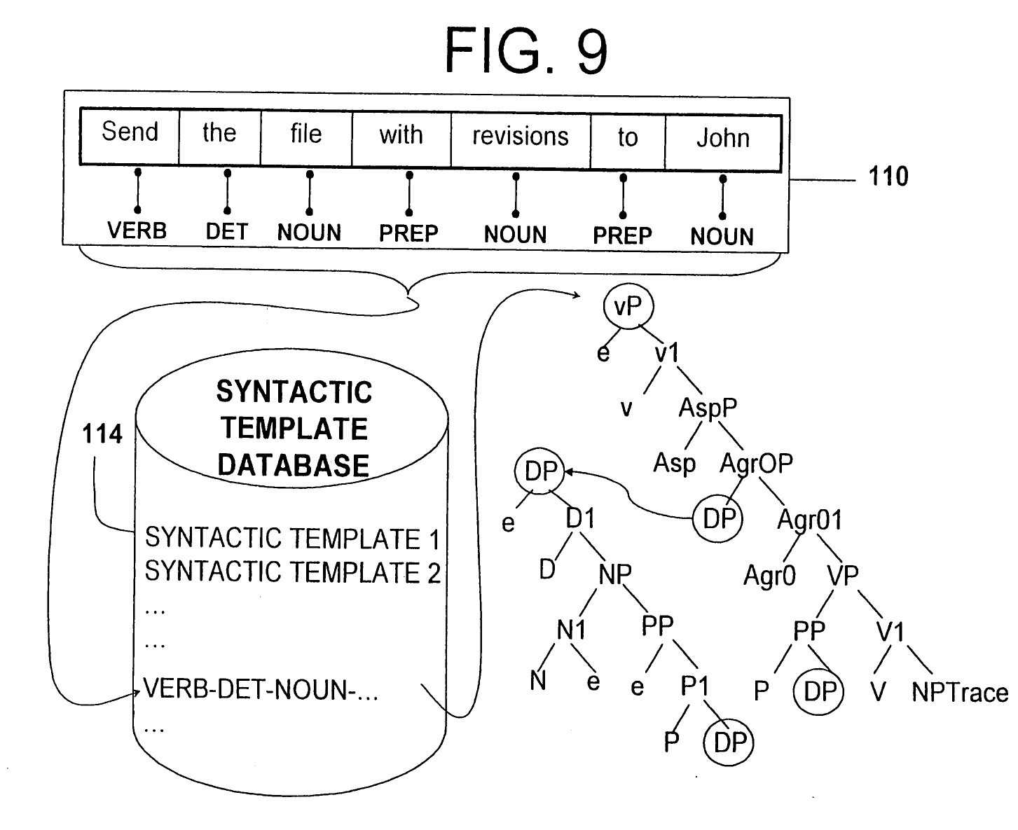

Reference is now made to FIG. 9, which is a simplified illustration of the use of syntactic templates when an entire sentence is covered by a syntactic template. In this case, the entire sentence representation, e.g. VERB-DET-NOUN-PREP-NOUN-PREP-NOUN appears in at least one single syntactic template.

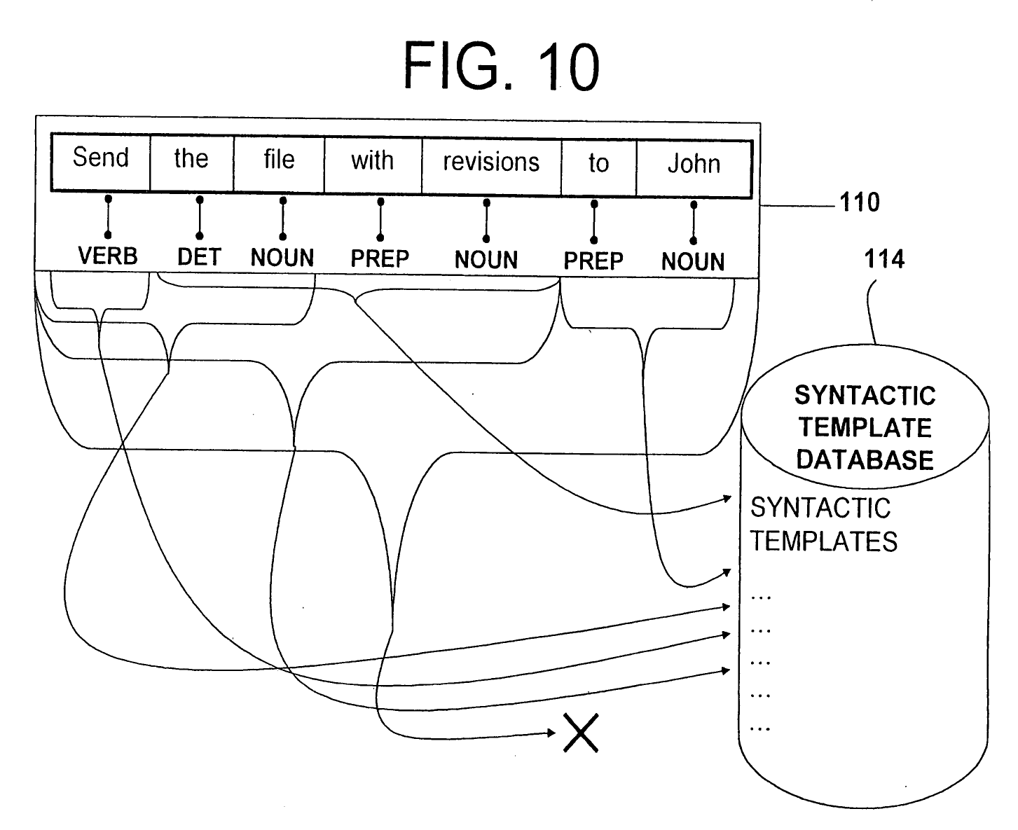

Reference is now made to FIG. 10, which is a simplified illustration of the use of syntactic templates when an entire sentence is not covered by a syntactic template, but multiple templates are required to cover the sentence. As seen in FIG. 10, in this case. the entire sentence representation, e.g. VERB-DET-NOUN-PREP-NOUN-PREP-NOUN does not appear in any single syntactic template.

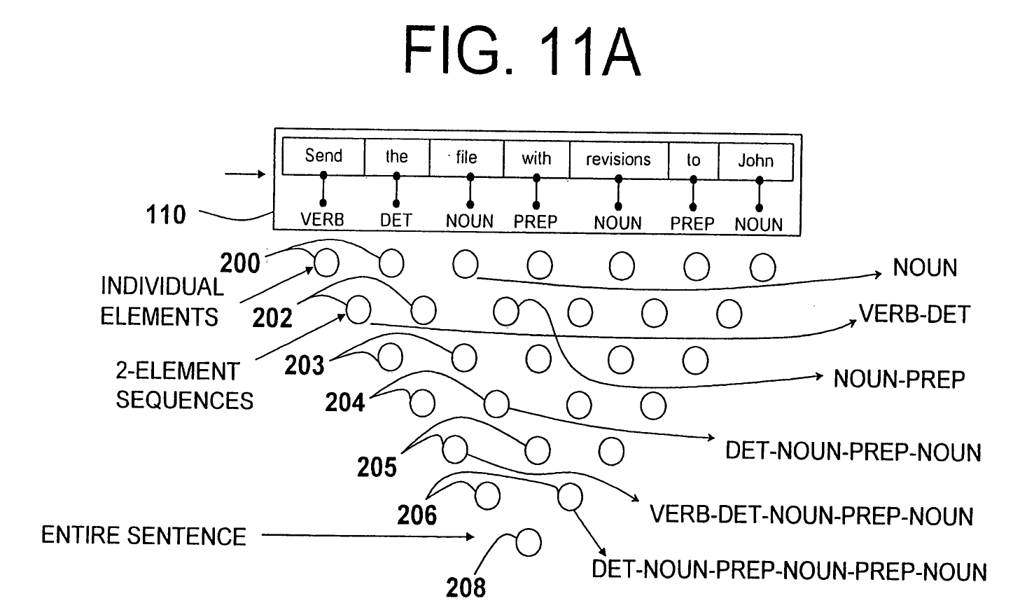

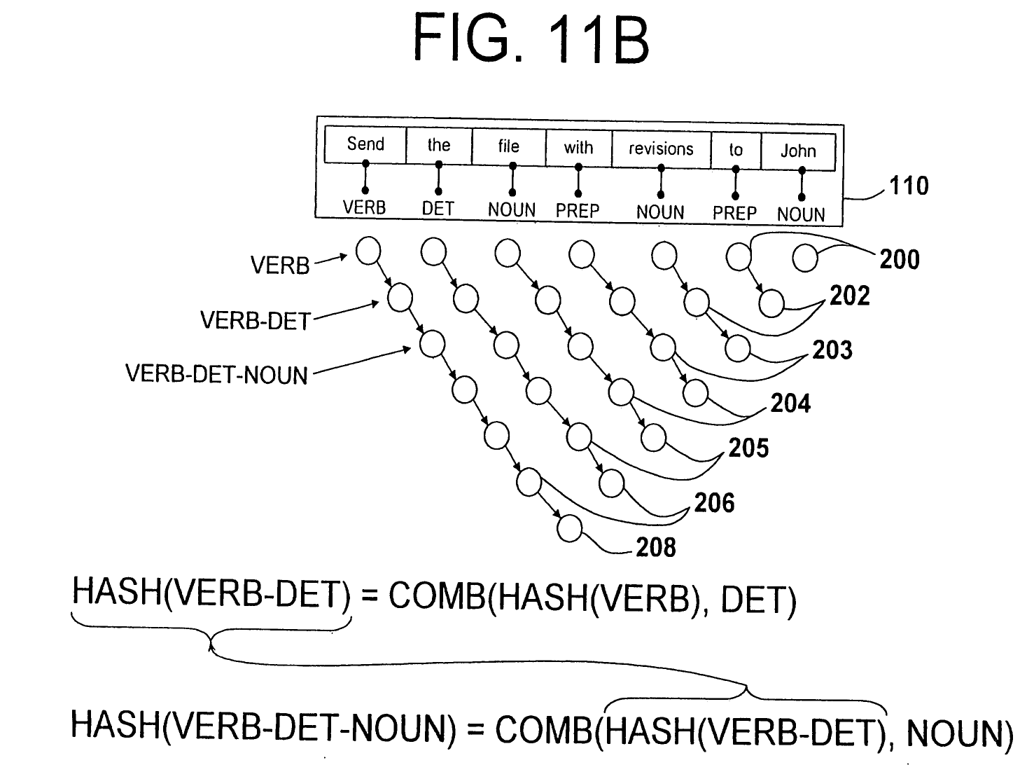

Reference is now made to FIGS. 11A and 11B, which are simplified illustrations of initial steps in an algorithm for parsing sentences using multiple syntactic templates in accordance with a preferred embodiment of the present invention. Turning initially to FIG. 11A, it is seen that memory objects representing all possible sub-sequences of the sentence representation 110 are created and are here typically arranged in a pyramidal structure. The base of the pyramid comprises memory objects representing single-element subsequences, here designated by reference numeral 200, such as VERB, DET and NOUN.

Objects representing two-element subsequences, such as VERB-DET, are typically designated by reference numeral 202. Objects representing three-element subsequences. such as VERB-DET-NOUN, are typically designated by reference numeral 203. Objects representing four-element subsequences, such as VERB-DET-NOUN-PREP, are designated by reference numeral 204.

Objects representing five-element subsequences, such as VERB-DET-NOUN-PREP-NOUN, are designated by reference numeral 205 and objects representing six-element subsequences, such as VERB-DET-NOUN-PREP-NOUN-PREP, are typically designated by reference numeral 206. In this example, an object representing the entire sequence is designated by reference numeral 208.

Turning. to FIG. 11B, it is seen symbolically that the objects are preferably created in an order illustrated by the arrows interconnecting the objects. These arrows represent creation of each. multiple-element object based on addition of an element to a previously created object having all but one of the same elements.

It is a particular feature of the present invention that a hash value is assigned to each memory object and that each multiple-element object is preferably assigned a hash value which is based on the hash value of the previously created object having all but one of the same elements on which it is based and the hash value of the element added to that previously created object.

The relationship between hash values of the memory objects is

preferably expressed as follows:

HASH(MULTI-ELEMENT OBJECT)=COMB (HASH (PREVIOUSLY CREATED OBJECT), ADDED ELEMENT)

For one specific example, the relationship may thus be expressed as follows:

HASH (VERB-DET)=COMB (HASH (VERB), DET)

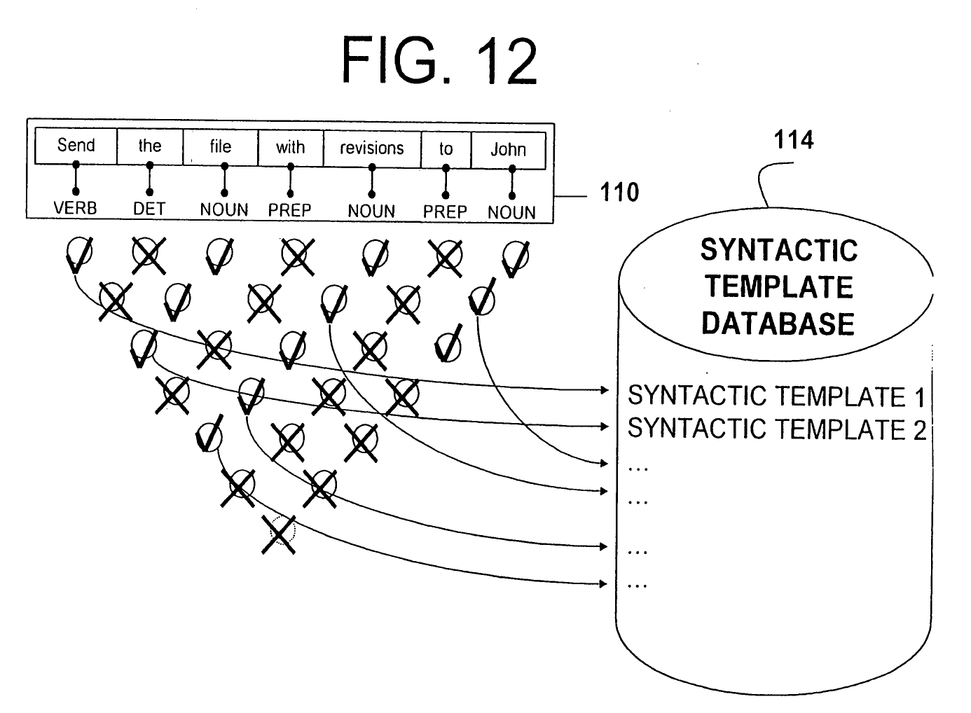

Reference is now made to FIG. 12, which is a simplified illustration of a further step in an algorithm for parsing sentences using multiple syntactic templates in accordance with a preferred embodiment of the present invention. As seen in FIG. 12, the hash values of each memory object are employed to search the syntactic template database for a match between the subsequence represented by each object and a syntactic template containing the same subsequence. The objects for whom a match is found are designated by a check mark, while those objects for whom a match is not found are designated by an X. It should be noted that the memory object which corresponds to the entire sentence, which has already been checked, as illustrated in FIG. 9. is not considered for further processing and is hence displayed differently.

Reference is now made to FIGS. 13A and 13B, which are simplified illustrations of still further steps in an algorithm for parsing sentences using multiple syntactic templates in accordance with a preferred embodiment of the present invention.

FIG. 13A shows various possibilities for selection of a sentence subsequence, having a matched syntactic template, for further processing. One such possibility is the longest subsequence, identified by reference numeral 250, which is typically the subsequence which is closest to the tip of the pyramid. Another such possibility is the longest noun phrase, which is the sentence subsequence, identified by reference numeral 250, containing a noun phrase which is closest to the tip of the pyramid.

The selection of one of the various possibilities is made in accordance with the heuristic philosophy governing the implementation of parsing in a given embodiment. For example, if the complexity of the parsing operation is believed to reside in understanding the nouns, the longest noun phrase may be initially selected. In most other cases, the longest subsequence would be selected, as illustrated in FIG. 13B.

Reference is now made to FIGS. 14A, 14B, 14C and 14D, which are simplified illustrations of yet further steps in an algorithm for parsing sentences using multiple syntactic templates in accordance with a preferred embodiment of the present invention.

As seen in FIG. 14A, the syntactic template corresponding to the selected subsequence, here the longest subsequence, is resolved into a corresponding partial parse tree. Thus, analogous to that seen in FIG. 5B, the syntactic template, designated by reference numeral 260, including a sequence of types of words, here VERB-DET-NOUN-PREP-NOUN is resolved into a partial parse tree 262, analogous to tree 140 of FIG. 4, respectively representing a full light verb phrase and a full determiner phrase, also referred to as a noun phrase.

FIG. 14B shows replacing the selected subsequence of FIG. 14A, with the partial parse tree 262 into which that subsequence was resolved, thereby creating a new sentence representation, here designated by reference numeral 270, which is equivalent to the original sentence representation 110 of FIG. 2.

This equivalence is clearly shown in FIG. 14C. It is appreciated that the position of the new sentence representation 270 of FIG. 14B, which is represented by the partial parse tree 262, as in FIG. 14A, is a valid linguistic construct inasmuch as it is in accordance with the rules of the linguistic grammar 116 of FIG. 2.

It is appreciated that the initial selection of a subsequence for further processing, as described hereinabove with reference to FIGS. 13A and 13B, is normally non-deterministic. The non-deterministic nature of the initial selection is illustrated in FIG. 14D. which shows two different new sentence representations which could be obtained by further processing based on different initial selections. The original sentence representation is designated by reference numeral 110, as in FIG. 2. New sentence representation 270 corresponds to the selection of subsequence 250, as in FIGS. 13B and 14B, while new sentence representation 280 corresponds to the selection not made in FIG. 13B, namely subsequence 252 of FIG. 13A.

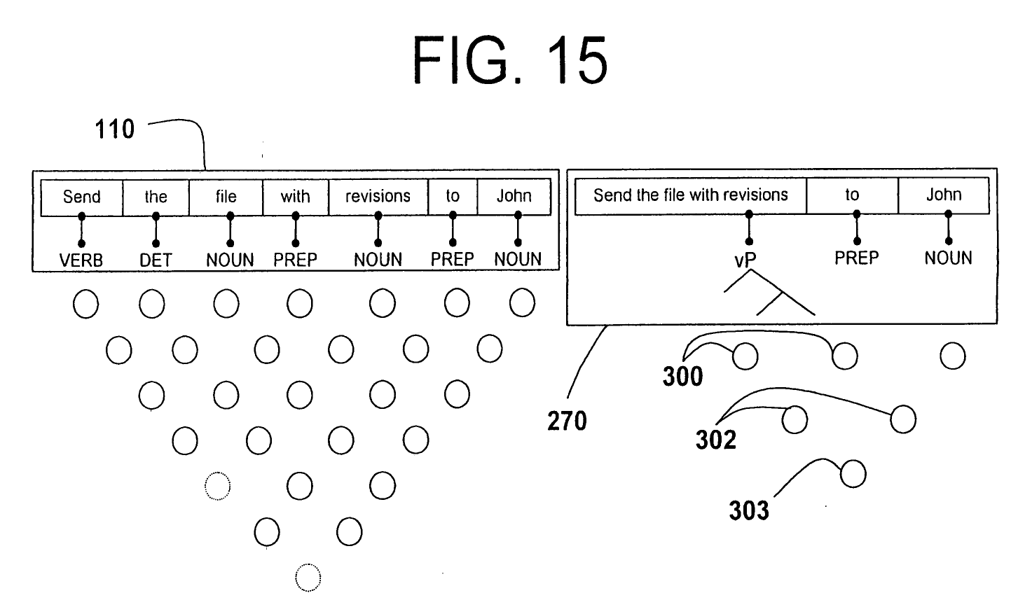

Reference is now made to FIG. 15, which is a simplified illustration of additional steps in an algorithm for parsing sentences using multiple syntactic templates in accordance with a preferred embodiment of the present invention. The new sentence representation 270, venerated as described hereinabove with reference to FIG. 14B, is processed in a manner analogous to that described hereinabove with reference to FIGS. 11A and 11B. As seen on the right side of FIG. 15, memory objects representing all possible sub-sequences of the new sentence representation 110 are created and are here typically arranged in a pyramidal structure. The base of the pyramid comprises single-element subsequences, here designated by reference numeral 300, such as VERB PHRASE, PREP and NOUN. It is appreciated that in contrast to the situation in FIG. 11A, here, not all of the single-element subsequences are words, because the VERB PHRASE is here treated as a single element.

Objects representing two-element subsequences, such as VERB PHRASE-PREP. are typically designated by reference numeral 302. Objects representing three-element subsequences, such as VERB PHASE-PREP-NOUN, are typically designated by reference numeral 303. In this example, there exists only one such object. which here represents the entire sequence.

It is a particular feature of the present invention that further processing of the various subsequences takes place not only in an iterative converging manner until a single sentence representation, including a parse tree representing the entire sentence, is generated. Instead, due to the non-deterministic nature of the parsing process of the present invention, alternative selections of subsequences are made at various stages of the iterative process, thereby providing, at various stages, sentence representations which include parse trees representing the entire sentence or part thereof

For this reason, the original pyramidal structure of FIG. 11A and the new pyramidal structure are shown side by side in FIG. 15, and the memory objects are iteratively processed identically. In particular, the selection shown in FIGS. 13A and 13B considers all memory objects and not merely the latest memory objects.

This feature is illustrated in FIG. 16, which is a simplified illustration of iteration in an algorithm for parsing sentences using multiple syntactic templates in accordance with a preferred embodiment of the present invention, as described hereinabove. It is noted that in the sentence representations shown in FIGS. 16, 17A, 17B and 20B, the original input sentence 101 is referenced by the initial letters of each word, thus, the letters ‘S’, ‘t’, ‘f’, ‘w’, ‘r’, ‘t’ and ‘J’, respectively, represent the words of the input sentence 101, ‘send’, ‘the’, ‘file’, ‘with’, ‘revisions’, ‘to’ and ‘John’.

As seen in FIG. 16, the algorithm selects a memory object from the first sentence representation 110 for further processing, rather than continuing to process the second sentence representation 270. A new sentence representation 280 is generated.

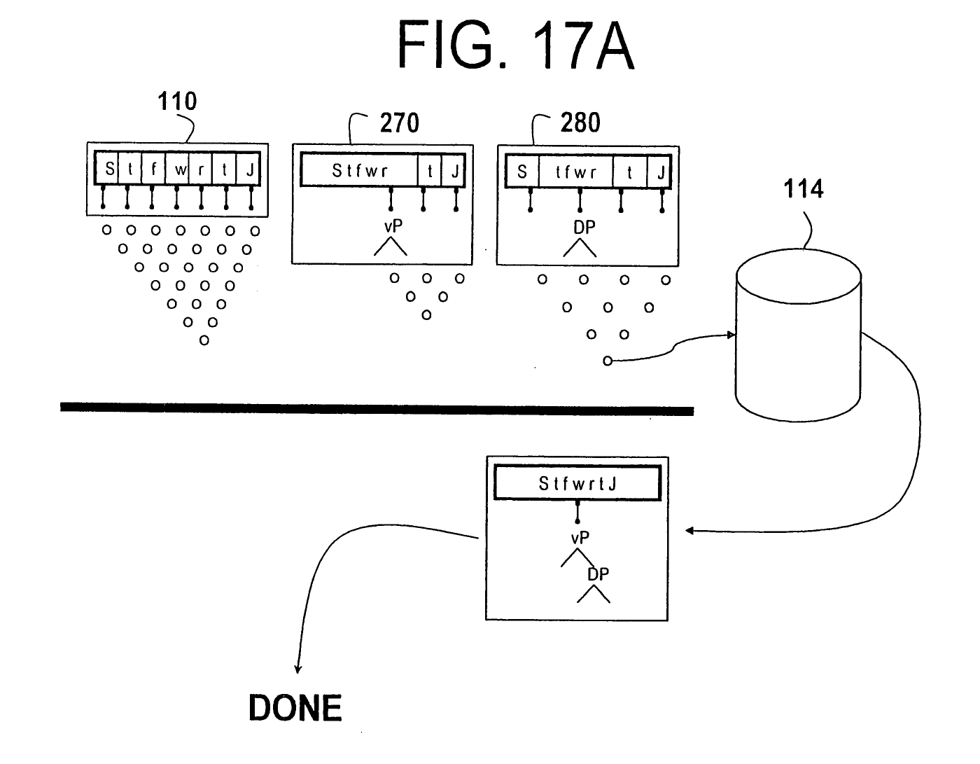

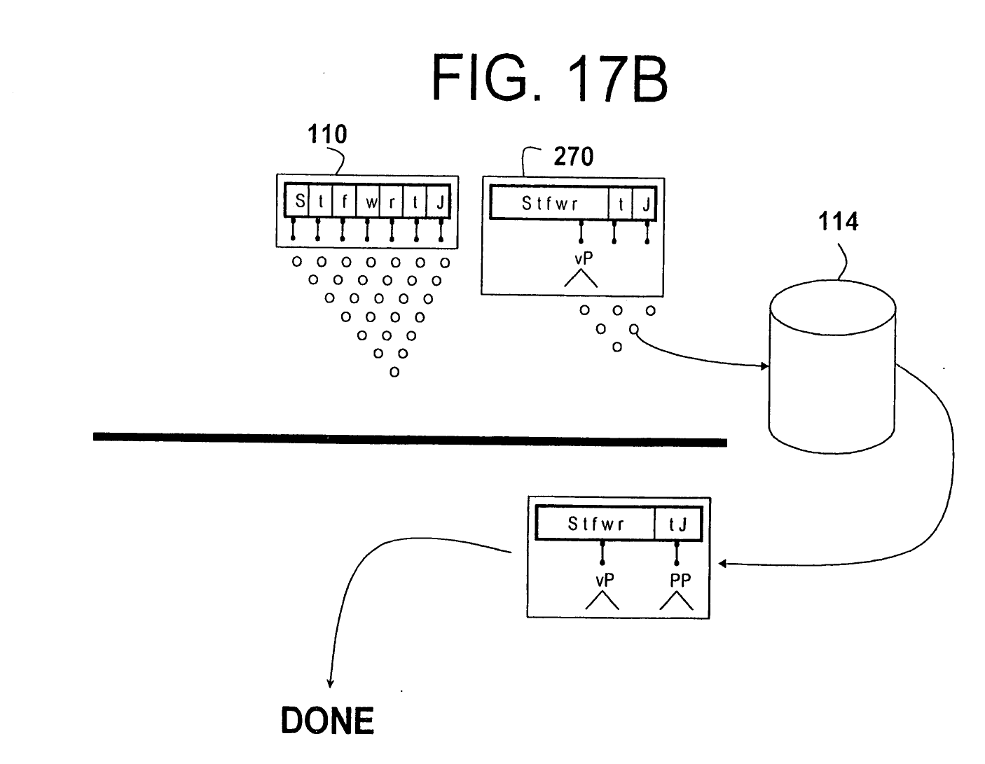

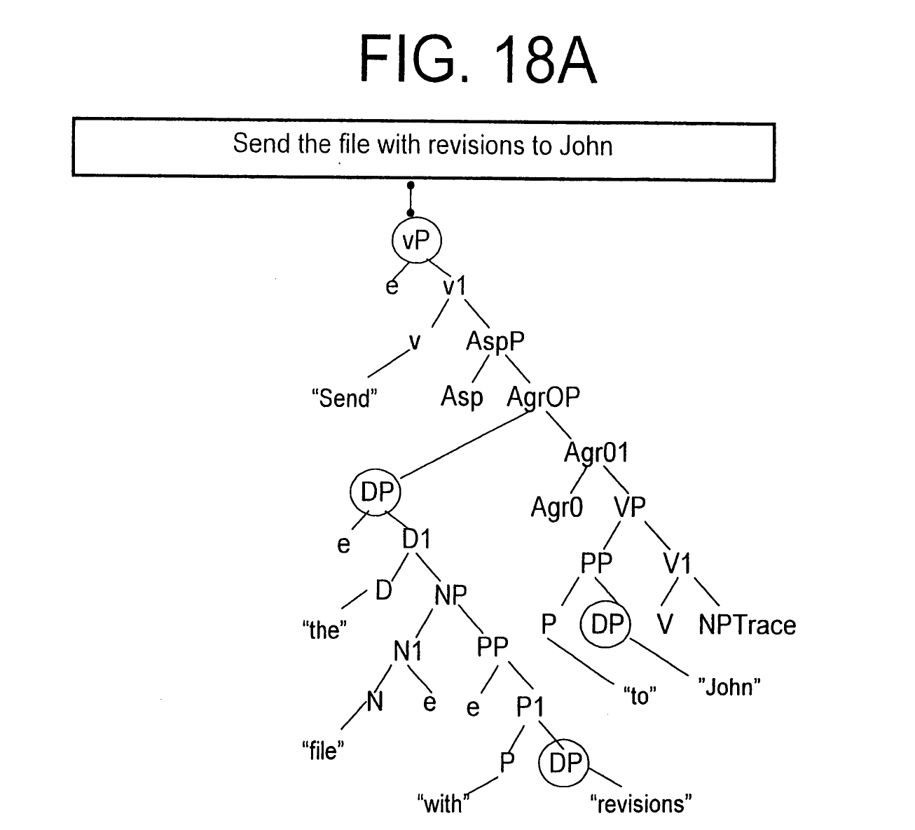

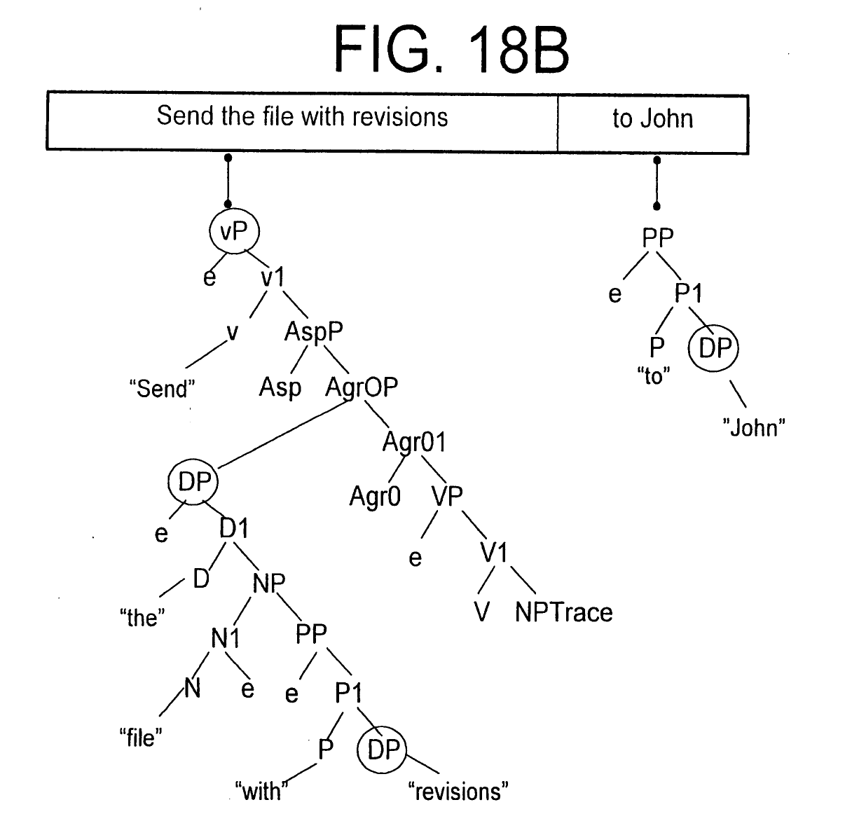

Reference is now made to FIG. 17A, which is similar to FIG. 16, and shows an instance wherein the algorithm obtains a complete sentence representation, including a parse tree representing the entire sentence, and heuristically determines that the sentence representation is acceptable. FIG. 17B, which is similar to FIG. 17A, shows an instance wherein the algorithm heuristically determines that a sentence representation is final, notwithstanding that it may not be complete, and decides to terminate the iterative process. Clearly, FIG. 17A represents a more desired result, which is reached in most cases. The parse trees resulting from FIGS. 17A and 17B appear in FIGS. 18A and 18B. respectively. It is appreciated that the decision to terminate the iterative process without necessarily achieving, a complete sentence representation, as in FIG. 17B, may be based on linguistic considerations, time considerations, or any other suitable methodology.

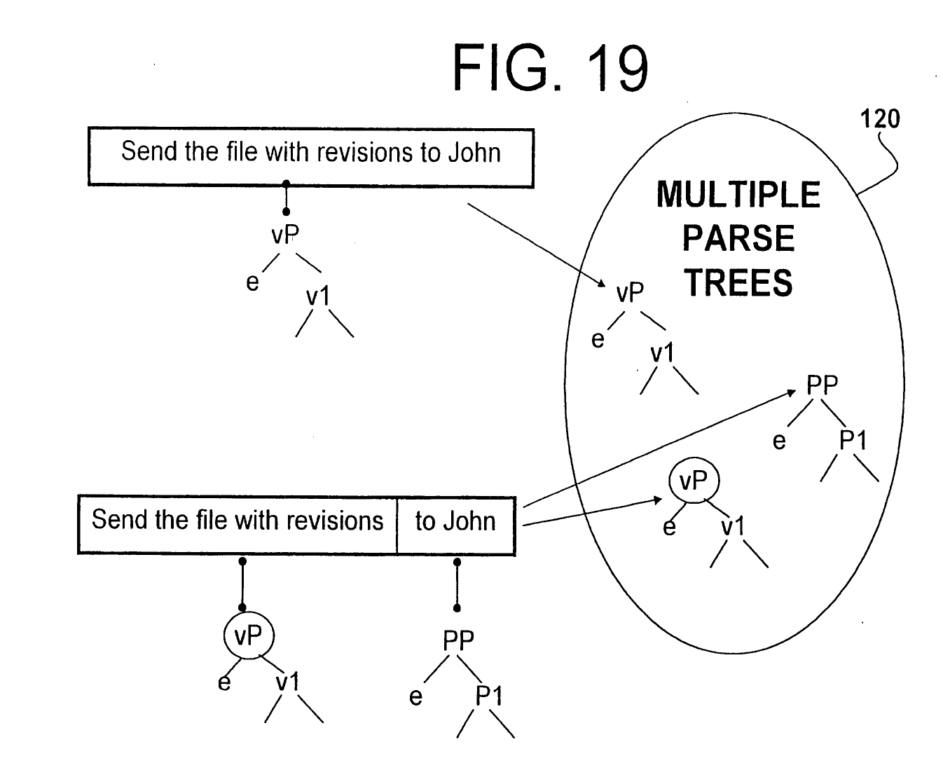

Reference is now made to FIG. 19, which is a simplified illustration of harvesting multiple parse trees produced by interactive parsing in accordance with a preferred embodiment of the present invention. As seen in FIG. 19, multiple parse trees 120, as shown in FIG. 2, preferably representing multiple alternative results of the type shown in FIG. 18A and of the type shown in FIG. 18B, are preferably retained and employed in accordance with a preferred embodiment of the present invention.

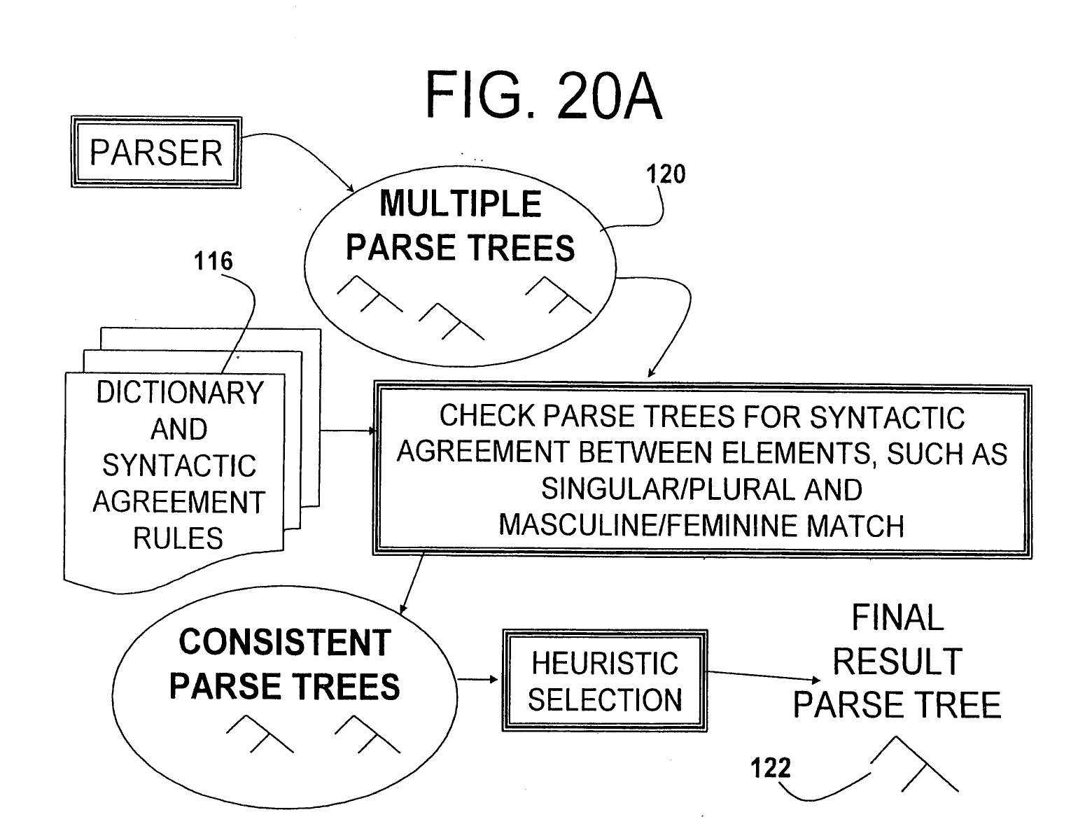

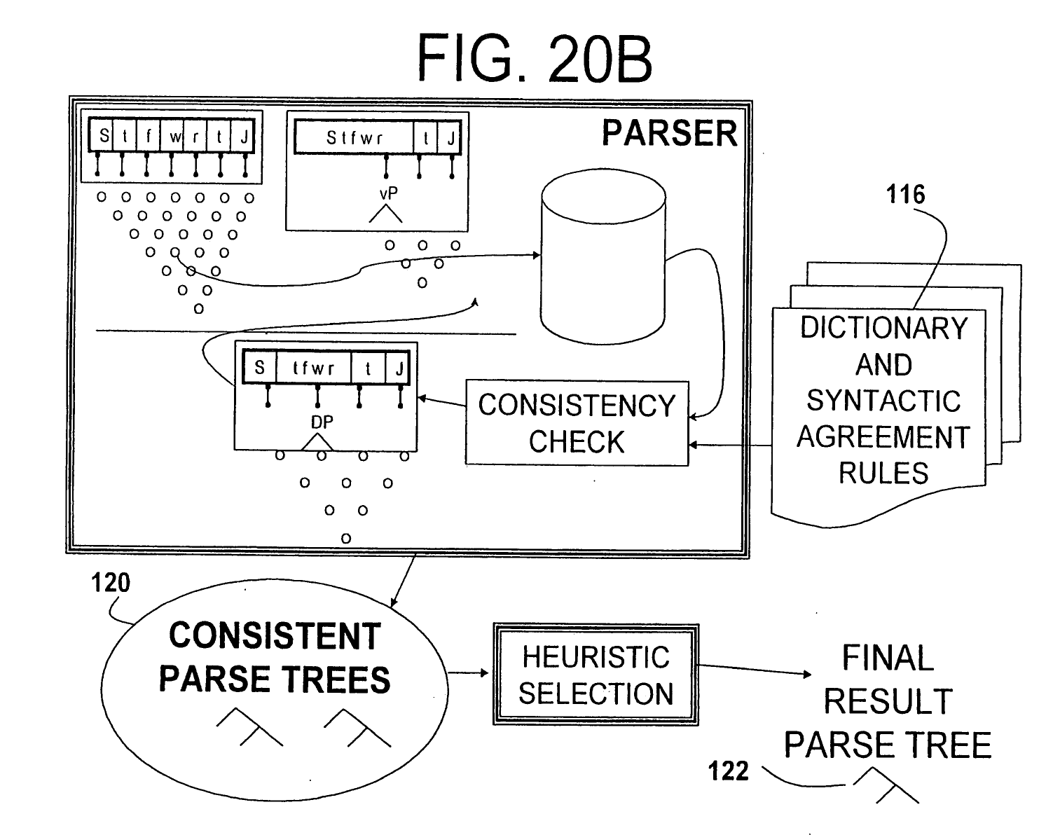

Reference is now made to FIGS. 20A and 20B, which are simplified illustrations of parse tree consistency checking, preferably employed in accordance with a preferred embodiment of the present invention. FIG. 20A shows a consistency checking functionality taking place in a real-time post-parsing context in the sense of FIG. 2. The multiple parse trees 120 are checked and filtered, preferably using a dictionary and the linguistic language grammar 116 to eliminate parse trees having syntactic agreement mismatches. Examples of such mismatches are singular/plural mismatches, masculine/feminine mismatches, grammatical case mismatches, person mismatches and definiteness mismatches. The consistency checking may also provide for the unification of syntactic features of one or more pairs of elements in a parse tree, as known in linguistics, such as a mother-daughter pair of elements or a probe-goal pair of elements. A heuristic selection may then be made from the remaining parse trees to obtain the final result parse tree 122.

FIG. 20B shows a consistency checking functionality taking place during parsing in the sense of FIG. 2. As each sentence representation is created, they are preferably checked and filtered, preferably using a dictionary and the linguistic language grammar 116, to eliminate sentence representations containing partial parse trees having syntactic agreement mismatches. Examples of such mismatches are singular/plural mismatches, masculine/feminine mismatches, grammatical case mismatches, person mismatches and definiteness mismatches. As noted above, the consistency checking may also provide for the unification of syntactic features of one or more pairs of elements in a parse tree, as known in linguistics, such as a mother-daughter pair of elements or a probe-goal pair of elements. A heuristic selection may then be made from the multiple parse trees 120, which are, in this instance, all consistent with the syntactic agreement rules, to obtain the final result parse tree 122.

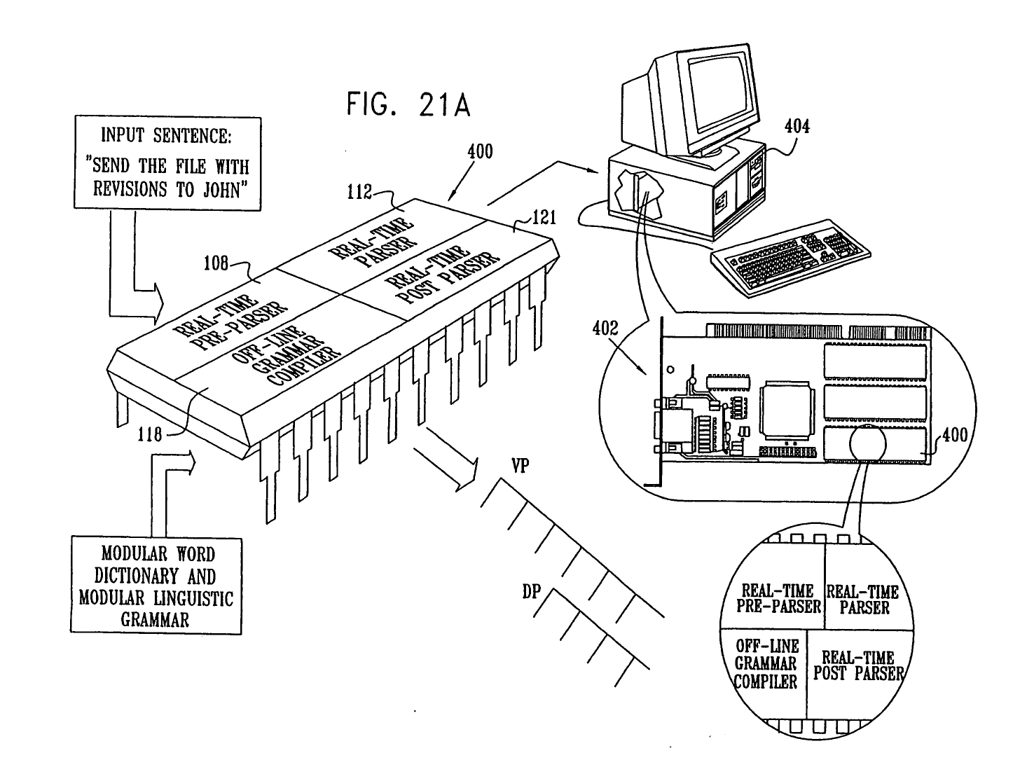

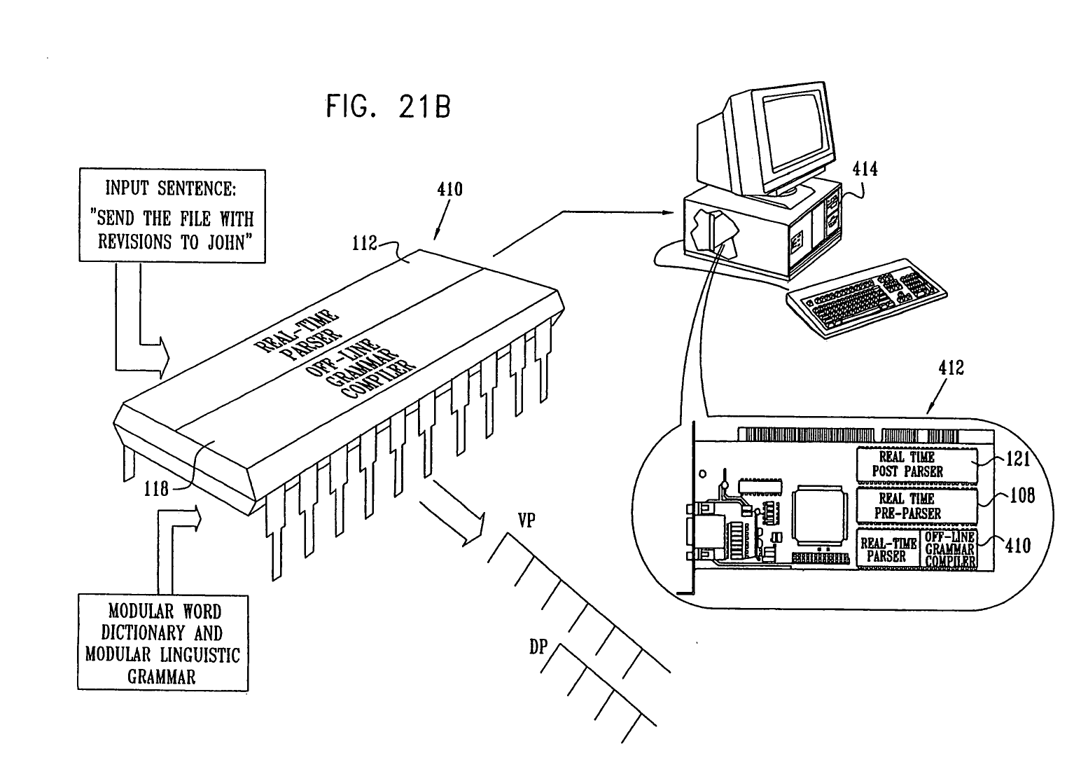

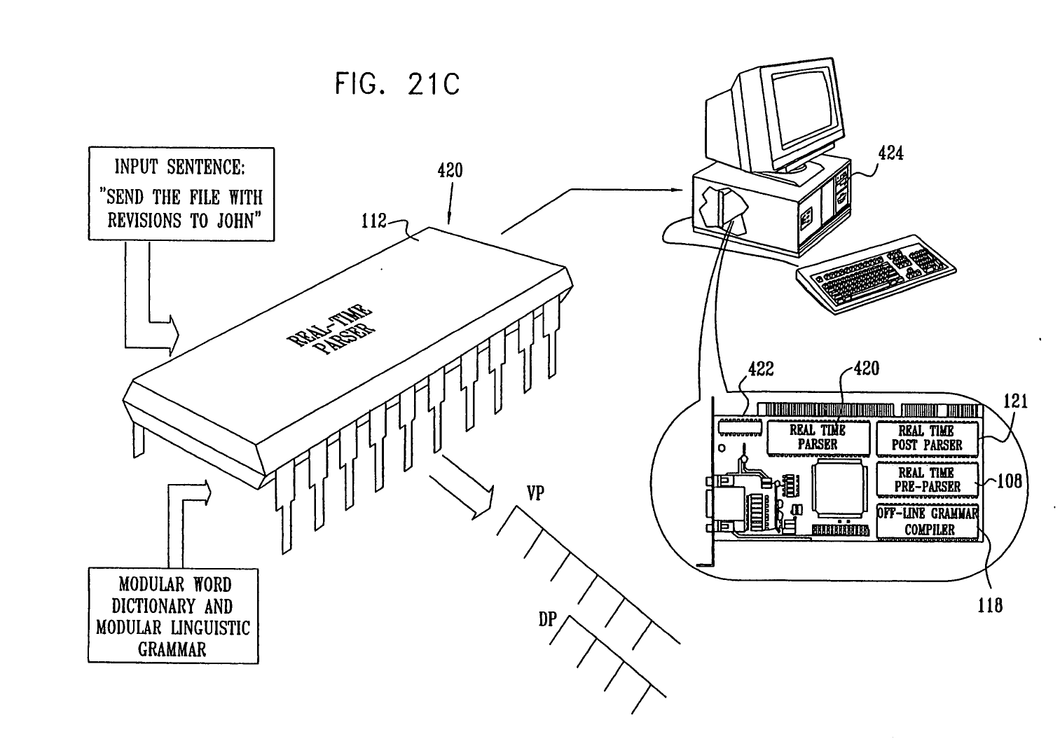

Reference is now made to FIGS. 21A, 21B and 21C, which are simplified symbolic illustrations of another preferred embodiment of the present invention. As seen in FIG. 21A, the parsing engine is embedded in an integrated circuit chip 400. In this embodiment of the present invention, the parsing engine comprises an off-line grammar compiler 118, real-time pre-parser 108, real-time parser 112 and real-time post-parser 121, as seen in FIG. 2. The integrated circuit chip 400 may then be mounted on a conventional hardware-circuit board 402, which may then be included in a PC 404.

FIG. 21B illustrates another embodiment of the present invention, where portions of the parsing, engine are embedded in an integrated circuit chip 410. In the illustrated embodiment, the parsing engine comprises off-line grammar compiler 118 and real-time parser 112, as seen in FIG. 2. Integrated circuit chip 410 may then be mounted on a conventional hardware circuit board 412, which may then be included in a PC 414. In tile illustrated embodiment, real-time pre-parser 108 and real-time post-parser 121 are included as other hardware embodiments. It is appreciated that real-time pre-parser 108 and real-time post-parser 121 could be implemented via any suitable hardware and/or software implementation.

FIG. 21C illustrates yet another embodiment of the present invention, where real-time parser 112 is embedded in an integrated circuit chip 420. Integrated circuit chip 420 may then be mounted on a conventional hardware circuit board 422, which may then be included in a PC 424. In the illustrated embodiment, off-line grammar compiler 118, real-time pre-parser 108 and real-time post-parser 121 are included as other hardware embodiments. It is appreciated that off-line grammar compiler 118, real-time pre-parser 108 and real-time post-parser 121 could be implemented via any suitable hardware and /or software implementation.

It is appreciated that in addition to the portions of the parsing engine specifically shown in the embodiments of FIGS. 21A-21C, any suitable portion of the parsing engine described hereinabove may be similarly embedded in an integrated circuit chip. This portion may comprise any of the following functionalities: real-time pre-parsing, off-line grammar compiling, real-time parsing, memory object processing, hash code calculating, syntactic database searching, partial parse tree building, real-time post-parsing, and syntactic feature unifying.

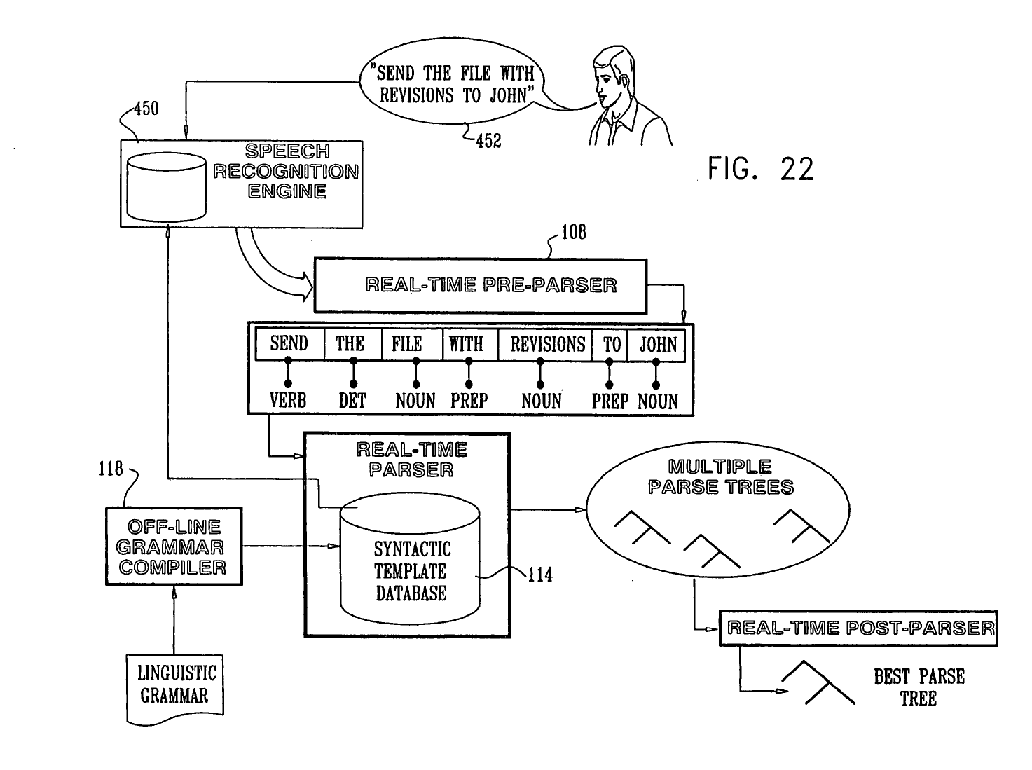

Reference is now made to FIG. 22, which is a simplified symbolic illustration or yet another preferred embodiment of the present invention. In the embodiment of FIG. 22, the parsing engine also includes a speech recognition engine 450, which also utilizes the compiled syntactic template database 114 to process spoken input sentence 452 into a suitable format for input into real-time pre-parser 108.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1-179. (Cancelled)

180. A parsing engine comprising:
an off-line grammar compiler; and
a parser which employs a pre-compiled grammar provided by said off-line grammar compiler, said pre-compiled grammar including a set of sequences of types of words which can be directly matched to at least part of a sentence.

181. A parsing engine according to claim 180 and wherein said pre-compiled grammar comprises a multiplicity of tree constructs.

182. A parsing engine according to claim 181 and wherein said tree constructs are linked collections of grammatical elements, said linked collections of grammatical elements including at least one of a bifurcated element, an initial element, a phase domain element and a non-bifurcated element, and characterized by at least one of the following:
1. each bifurcated element represents a selectional restriction in the grammar;
2. the initial element is a phase domain element, as known in linguistics;
3. other than the initial element, no phase domain element is bifurcated; and
4. all non-bifurcated elements are either phase domains, words or empty category elements, as known in linguistics.

183. A parsing engine according to claim 182 and wherein:
said tree constructs comprise decomposition of a language element into other language elements or word types;
said pre-compiled grammar employs said tree constructs to generate a plurality of syntactic templates and associated partial parse trees; and
said syntactic templates and associated partial parse trees are stored in a syntactic template database.

184. A parsing engine according to claim 182 and wherein:
said parser generates at least one matched syntactic template by initially attempting to match an entire sentence representation, and failing that, attempting to match at least one most appropriate subdivision thereof, to syntactic templates stored in a syntactic template database; and
said at least one matched syntactic template is employed to define a partial parse tree.

185. A parsing engine according to claim 183 and wherein:
said parser generates at least one matched syntactic template by initially attempting to match an entire sentence representation, and failing that, attempting to match at least one most appropriate subdivision thereof, to syntactic templates stored in said syntactic template database; and
said at least one matched syntactic template is employed to define a partial parse tree.

186. A parsing engine according to claim 184 and wherein:
each multiple-element object is assigned a hash value based on the hash value of a previously created object having all but one of the same elements and the element added to that previously created object, the relationship between hash values of the memory objects being expressed as follows:
HASH (MULTI-ELEMENT OBJECT)=COMB (HASH (PREVIOUSLY CREATED OBJECT), ADDED ELEMENT); and
the hash value of at least one memory object is employed to search the syntactic template database for a match between the subsequence represented by said at least one memory object and a syntactic template containing the same subsequence.

187. A parsing engine according to claim 185 and wherein:
each multiple-element object is assigned a hash value based on the hash value of a previously created object having all but one of the same elements and the element added to that previously created object, the relationship between hash values of the memory objects being expressed as follows:
HASH (MULTI-ELEMENT OBJECT)=COMB (HASH (PREVIOUSLY CREATED OBJECT), ADDED ELEMENT); and
the hash value of at least one memory object is employed to search the syntactic template database for a match between the subsequence represented by said at least one memory object and a syntactic template containing the same subsequence.

188. A parsing engine according to claim 187 and wherein:
said parser eliminates parse trees having syntactic agreement mismatches;
some syntactic features of at least one pair of grammatical elements in said parse trees undergo unification; and
said at least one pair of grammatical elements is a mother-daughter pair of elements or a probe-goal pair of elements.

189. A parsing engine according to claim 188 and wherein at least a portion of said parser is included on an integrated circuit chip.

190. A parsing method comprising:
compiling a grammar off-line; and
parsing employing said grammar, said grammar including a set of sequences of types of words which can be directly matched to at least part of a sentence.

191. A parsing method according to claim 190 and wherein said compiling comprises generating a multiplicity of tree constructs.

192. A parsing method according to claim 191 and wherein said tree constructs are linked collections of grammatical elements, said linked collections of grammatical elements including at least one of a bifurcated element, an initial element, a phase domain element and a non-bifurcated element, and characterized by at least one of the following:
1. each bifurcated element represents a selectional restriction in the grammar;
2. the initial element is a phase domain element, as known in linguistics;
3. other than the initial element, no phase domain element is bifurcated; and
4. all non-bifurcated elements are either phase domains, words or empty category elements, as known in linguistics.

193. A parsing method according to claim 192 and wherein:
said tree constructs comprise decomposition of a language element into other language elements or word types; and
said compiling comprises:
generating a plurality of syntactic templates and associated partial parse trees employing said tree constructs; and
storing said syntactic templates and associated partial parse trees in a syntactic template database.

194. A parsing method according to claim 192 and wherein said parsing comprises:
generating at least one matched syntactic template by initially attempting to match an entire sentence representation, and failing that, attempting to match at least one most appropriate subdivision thereof, to syntactic templates stored in a syntactic template database; and
employing said at least one matched syntactic template to define a partial parse tree.

195. A parsing method according to claim 193 and wherein said parsing comprises:
generating at least one matched syntactic template by initially attempting to match an entire sentence representation, and failing that, attempting to match at least one most appropriate subdivision thereof, to syntactic templates stored in said syntactic template database; and
employing said at least one matched syntactic template to define a partial parse tree.

196. A parsing method according to claim 194 and also comprising:
assigning a hash value to a multiple-element object based on the hash value of a previously created object having all but one of the same elements and the element added to that previously created object, the relationship between hash values of the memory objects being expressed as follows:
HASH (MULTI-ELEMENT OBJECT)=COMB (HASH (PREVIOUSLY CREATED OBJECT), ADDED ELEMENT); and
employing the hash value of at least one memory object to search the syntactic template database for a match between the subsequence represented by said at least one memory object and a syntactic template containing the same subsequence.

197. A parsing method according to claim 195 and also comprising:
assigning a hash value to a multiple-element object based on the hash value of a previously created object having all but one of the same elements and the element added to that previously created object, the relationship between hash values of the memory objects being expressed as follows:
HASH (MULTI-ELEMENT OBJECT)=COMB (HASH (PREVIOUSLY CREATED OBJECT), ADDED ELEMENT); and
employing the hash value of at least one memory object to search the syntactic template database for a match between the subsequence represented by said at least one memory object and a syntactic template containing the same subsequence.

198. A parsing method according to claim 197 and wherein:
said parsing also comprises eliminating parse trees having syntactic agreement mismatches;
some syntactic features of at least one pair of grammatical elements in said parse trees undergo unification; and
said at least one pair of grammatical elements is a mother-daughter pair of elements or a probe-goal pair of elements.
